(19) United States
(12) Patent Application Publication
(10) Pub. No.: US 2016/0137752 A1
(43) Pub. Date: May 19, 2016

(54) PACKAGING FORMULATION FOR PREVENTING THE INSOLUBILITY OF CHITOSAN-CONTAINING COMPOSITIONS

(71) Applicant: HaloSource, Inc., Bothell, WA (US)

(72) Inventors: Everett J. Nichols, Edmonds, WA (US); James R. Scott, Bellevue, WA (US); John P. Carroll, Bothell, WA (US)

(73) Assignee: HALOSOURCE, INC., Bothell, WA (US)

(21) Appl. No.: 14/885,179

(22) Filed: Oct. 16, 2015

Related U.S. Application Data
(62) Division of application No. 13/503,316, filed on May 30, 2012, now abandoned.
(60) Provisional application No. 61/255,413, filed on Oct. 27, 2009.

(51) Int. Cl. C08B 37/08; B65B 63/08; C09K 3/00

(52) U.S. Cl. CPC C08B 37/003; C09K 3/00; B65B 63/08

(57) ABSTRACT

Formulations, methods, and products for preventing or decreasing insolubilization of chitosan-containing compositions are provided. By employing embodiments discussed herein, the ability of a chitosan-containing composition to properly solubilize at a desired time may be preserved.

### CROSS-REFERENCES TO RELATED APPLICATIONS

This application is a division of U.S. patent application Ser. No. 13/503,316, filed May 30, 2012, which is the national stage of International Patent Application No. PCT/US2010/053966, filed Oct. 25, 2010, which claims the benefit of U.S. Provisional Application No. 61/255,413, filed Oct. 27, 2009, all of which applications are incorporated herein by reference in their entirety.

### BACKGROUND

Chitosan is a polysaccharide derived from the shells of crustaceans such as shrimp, crab, and lobster. Chitosan is insoluble in water and soluble in dilute acid solutions. Chitosan salts can be created by mixing dry water-insoluble chitosan with organic acids in an aqueous solvent solution and then drying the mix. Once the solvent is evaporated, the resulting dry solid chitosan salt is water soluble. Dried solid chitosan salts or dried solid blends of water-insoluble chitosan mixed with dry solid acids (to render the chitosan soluble) can be contained within a porous device that comprises a segmented fabric sock which can be placed in a flow of water that contains suspended particulate matter such as sediment or organic matter or algae. As water flows over the sock, the chitosan dissolves and is released through the pores of the segmented fabric socks where it then contacts the suspended particulate material in the water and causes the particulates to aggregate or form floccules or aggregates that can then be removed from the aqueous stream by filtration. This type of device is typically used in stormwater applications where water running off of a construction site contains suspended sediment that must be removed (by filtration or settling) before discharge into the environment. Since chitosan must be dissolved in order to function in aggregation or flocculation of suspended materials such as sediment or organic or inorganic matter, it is important to maintain the water-solubility of the solid chitosan/solid acid mixture or solid chitosan salt during transport and storage. A need exists to facilitate the solubility of chitosan-containing compositions.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Devices meant to release chitosan into water sometimes do not function in the field and are not successful in aggregating or floccing suspended sediment. In some circumstances, chitosan salt contained within devices does not dissolve and therefore the chitosan is not released through the fabric pores and therefore not capable of aggregating the suspended sediment contained in the water. Described herein is a means to prevent such device failure. The inventors discovered that exposure of chitosan-containing compositions to heat, moisture, or heat and moisture over time results in the chitosan becoming water-insoluble. A packaging system or design was then developed that would protect the chitosan-containing compositions from becoming insoluble when exposed to high temperatures, humidity, or a combination thereof during storage and transport.

Accordingly, some embodiments provide a formulation comprising: a chitosan-containing composition chosen from: a) a chitosan salt; b) a blend of (1) a solid chitosan that may be partially protonated but is greater than 80% insoluble when added to water and in a dry, free-flowing, particulate form, and (2) a solid acid or a solid agent that generates a proton in situ in the presence of water; and c) a chitosan derivative, and a desiccant in an amount sufficient to prevent or decrease insolubilization of the chitosan-containing composition.

Other embodiments provide a sealed moisture-resistant container comprising: a formulation comprising a chitosan-containing composition and a desiccant, wherein the chitosan-containing composition is chosen from: a chitosan salt; a blend of (1) a solid chitosan that may be partially protonated but is greater than 80% insoluble when added to water and in a dry, free-flowing, particulate form, and (2) a solid acid or a solid agent that generates a proton in situ in the presence of water; and a chitosan derivative, and wherein the amount of desiccant is sufficient to prevent or decrease insolubilization of the chitosan-containing composition.

Also provided is a method of preventing or decreasing insolubilization of a chitosan-containing composition, the method comprising: placing a desiccant in a moisture-resistant container with a chitosan-containing composition, wherein the chitosan-containing composition is chosen from: a chitosan salt; a blend of (1) a solid chitosan that may be partially protonated but is greater than 80% insoluble when added to water and in a dry, free-flowing, particulate form, and (2) a solid acid or a solid agent that generates a proton in situ in the presence of water; and a chitosan derivative, and wherein the amount of desiccant is sufficient to prevent or decrease insolubilization of the chitosan-containing composition.

Other embodiments provide a method of solubilizing a chitosan-containing composition, comprising: a) opening a sealed moisture-resistant container comprising a formulation comprising the chitosan-containing composition and a desiccant, wherein the chitosan-containing composition is chosen from: a chitosan salt; a blend of (1) a solid chitosan that may be partially protonated but is greater than 80% insoluble when added to water and in a dry, free-flowing, particulate form, and (2) a solid acid or a solid agent that generates a proton in situ in the presence of water; and a chitosan derivative, and wherein the amount of desiccant is sufficient to prevent or decrease insolubilization of the chitosan-containing composition, and b) exposing the chitosan-containing composition to water to solubilize the chitosan-containing composition.

Also provided is a method of desiccating a formulation comprising a chitosan-containing composition, the method comprising: sealing a formulation comprising the chitosan-containing composition and a desiccant in a moisture-resistant container, wherein the chitosan-containing composition is chosen from: a chitosan salt; a blend of (1) a solid chitosan that may be partially protonated but is greater than 80% insoluble when added to water and in a dry, free-flowing, particulate form, and (2) a solid acid or a solid agent that generates a proton in situ in the presence of water; and a chitosan derivative, and wherein the amount of desiccant is sufficient to prevent or decrease insolubilization of the chitosan-containing composition.

Containers are also provided, such as a sealed moisture-resistant container comprising: a) a porous device comprising a chitosan-containing composition; and b) a desiccant.

Also provided is a formulation comprising: a) a chitosan-containing composition chosen from: a chitosan salt; a blend of (1) a solid chitosan that may be partially protonated but is greater than 80% insoluble when added to water and in a dry, free-flowing, particulate form, and (2) a solid acid or a solid agent that generates a proton in situ in the presence of water; and a chitosan derivative, and one of b), c), or d): b) a Schiff base disruptor; c) a monosaccharide reducing sugar; or d) an amine-containing substance.

Further provided is a method for preventing or decreasing insolubilization of a chitosan-containing composition, comprising: a) reducing moisture within a container to provide a low-moisture container; b) placing a chitosan-containing composition within the low-moisture container; and c) sealing the low-moisture container.

Also provided is a method of preventing or decreasing insolubilization of a chitosan-containing composition, comprising: a) packaging a water soluble chitosan containing composition in a container; and b) maintaining the composition to a temperature to maintain the water-solubility of the chitosan-containing composition when exposure to ambient temperature would otherwise result in the insolubility of the chitosan-containing composition.

Further provided is a sealed product containing a water-soluble chitosan-containing composition, comprising: a chitosan-containing composition chosen from: a) a chitosan salt; b) a blend of (1) a solid chitosan that may be partially protonated but is greater than 80% insoluble when added to water and in a dry, free-flowing, particulate form, and (2) a solid acid or a solid agent that generates a proton in situ in the presence of water; and c) a chitosan derivative, and a moisture content no greater than 10% by weight relative to the weight of the chitosan-containing composition.

Further provided is a chitosan-containing composition having a moisture content of less than 5% by weight relative to the chitosan-containing composition comprised in a moisture-resistant container.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A, 1B, and 1C depict a comparison of chitosan lactate Visual Solubility Scores;

FIGS. 2A, 2B, and 2C depict a comparison of chitosan lactate salts with different solubilities on kitchen strainers;

FIGS. 3A and 3B depict a comparison of chitosan lactate samples following a Screen Insolubles experiment;

FIGS. 4A and 4B depict results from a Conical Tube/Screen Assay studying the effects of heat (55° C.) and humidity on chitosan lactate samples;

FIGS. 5A and 5B depict a solubility comparison of chitosan lactate salts heated with or without desiccant at 100° C. for 7 days;

FIGS. 6A and 6B depict a solubility comparison of chitosan lactate salts heated with or without desiccant at 55° C. for 15 days;

FIGS. 7A, 7B, 7C, 7D, 7E, and 7F depict a comparison of color of dry chitosan lactates removed from Gel-Floc™ sock devices following exposure to different temperatures and conditions (7A: 28 day exposure to 55° C. in mylar, no desiccant; 7B: 28 day exposure to 55° C. in mylar containing 100 g silica gel desiccant; 7C: 28 day exposure to 55° C., sock stored open in oven; 7D: control, stored open at room temperature; 7E: 28 day exposure to 40° C. in mylar, containing 100 g silica gel desiccant; 7F: 28 day exposure to 40° C. in mylar, no desiccant);

FIG. 8 depicts a solubility comparison of chitosan lactate from Gel-Floc™ socks exposed to 55° C. or 40° C. while sealed in mylar with or without desiccant (Tube A: 28 day exposure to 55° C. in mylar, no desiccant; Tube B: 28 day exposure to 55° C. in mylar containing 100 g silica gel desiccant; Tube C: 28 day exposure to 55° C., sock stored open in oven; Tube D: control, stored open at room temperature; Tube E: 28 day exposure to 40° C. in mylar, containing 100 g silica gel desiccant; Tube F: 28 day exposure to 40° C. in mylar, no desiccant);

FIGS. 9A, 9B, 9C, 9D, 9E, and 9F depict the results of a Screen Insolubles comparison of chitosan lactate samples from FIG. 8;

FIG. 10 is a graph showing a comparison of sachet weights of desiccated and non-desiccated chitosan lactates exposed to constant temperature of 55° C. for 14 days;

FIGS. 11A, 11B, and 11C depict a comparison of chitosan lactate-containing sachets from FIG. 10 following 28 hours of stirring in water;

FIGS. 12A, 12B, 12C, 12D, 12E, 12F 12G, 12H, 12I, 12J, 12K, 12L, 12M, 12N, and 12O depict a color comparison of dry chitosan lactates sealed in mylar in the presence of different ratios of molecular sieve or silica gel desiccants exposed to 100° C. for 18 hours (FIGS. 12A-12H show chitosan lactate salts heated in mylar containing different amounts of silica gel desiccant to chitosan lactate salt. From top left to right: 3.6 kg desiccant/kg chitosan lactate salt; 5.4 kg desiccant/kg; 1.8 kg desiccant/kg; 902 grams desiccant/kg; 451 grams desiccant/kg; 226 grams desiccant/kg; 113 grams desiccant/kg; 0 grams desiccant/kg. FIGS. 12I-12O show chitosan lactate salts heated in mylar containing different amounts of molecular sieve desiccant to chitosan lactate salt. From left to right: 3.6 kg desiccant/kg chitosan lactate salt; 5.4 kg desiccant/kg; 1.8 kg desiccant/kg; 902 grams desiccant/kg; 451 grams desiccant/kg; 226 grams/kg; 113 grams desiccant/kg);

FIG. 13 depicts results of heating and humidity experiments testing solid chitosan/solid acid blends (note: any black particles seen in the photos are from the fabric sachet holding the admixture blend);

FIG. 14 depicts a representative embodiment of a device of the present invention comprising a segmented body (partially cut away); and

FIG. 15 depicts a cross-sectional view of the device shown in FIG. 14 which more clearly shows a composition disposed within the device.

### DETAILED DESCRIPTION

The inventors have discovered that exposure of chitosan-containing compositions to heat, moisture, or a combination thereof can result in insolubilization of the composition. The inventors subsequently discovered that the solubility of chitosan-containing compositions can be preserved by, for example, packaging the chitosan-containing composition in a moisture-resistant container containing an appropriate amount and type of desiccant. In this way, the chitosan-containing composition retains its ability to be water-soluble.

Disclosed herein are formulations and methods aimed at avoiding insolubility of chitosan compositions by removing moisture and/or preventing exposure of the compositions to excess heat.

For example, disclosed herein is a formulation comprising: a chitosan-containing composition chosen from: a) a chitosan salt; b) a blend of (1) a solid chitosan that may be partially protonated but is greater than 80% insoluble when added to water and in a dry, free-flowing, particulate form, and (2) a solid acid or a solid agent that generates a proton in situ in the presence of water; and c) a chitosan derivative, and a desiccant in an amount sufficient to prevent or decrease insolubilization of the chitosan-containing composition. The chitosan-containing composition may be any chitosan-containing composition defined herein, such as a chitosan salt (e.g., chitosan lactate). The chitosan-containing composition may be a blend further defined as solid chitosan combined with either sodium diacetate, adipic acid, benzoic acid, or glutamic acid. The chitosan-containing composition may be a chitosan derivative further defined as chitosan covalently modified to exhibit carbonyl functionality (e.g., succinylated chitosan). The desiccant may be further defined as molecular sieves, silica gel, montmorillonite clay, indicating silica gel, calcium oxide, calcium sulfate, or activated alumina, or a combination thereof. In some embodiments, the desiccant is molecular sieves or silica gel. In some embodiments, the chitosan-containing composition is a chitosan salt further defined as chitosan lactate and the desiccant is further defined as molecular sieves.

Other embodiments provide a sealed moisture-resistant container comprising: a formulation comprising a chitosan-containing composition and a desiccant, wherein the chitosan-containing composition is chosen from: a chitosan salt; a blend of (1) a solid chitosan that may be partially protonated but is greater than 80% insoluble when added to water and in a dry, free-flowing, particulate form, and (2) a solid acid or a solid agent that generates a proton in situ in the presence of water; and a chitosan derivative, and wherein the amount of desiccant is sufficient to prevent or decrease insolubilization of the chitosan-containing composition. Moisture-resistant containers are discussed further herein.

Also provided is a method of preventing or decreasing insolubilization of a chitosan-containing composition, the method comprising: placing a desiccant in a moisture-resistant container with a chitosan-containing composition, wherein the chitosan-containing composition is chosen from: a chitosan salt; a blend of (1) a solid chitosan that may be partially protonated but is greater than 80% insoluble when added to water and in a dry, free-flowing, particulate form, and (2) a solid acid or a solid agent that generates a proton in situ in the presence of water; and a chitosan derivative, and wherein the amount of desiccant is sufficient to prevent or decrease insolubilization of the chitosan-containing composition. The moisture-resistant container may be any type described herein, such as mylar. The desiccant may be any type described herein, such as molecular sieves, silica gel, montmorillonite clay, indicating silica gel, calcium oxide, calcium sulfate, or activated alumina. In some embodiments, the desiccant is molecular sieves or silica gel. In this or any other method, a further step of sealing the moisture-resistant container may be performed.

Other embodiments provide a method of solubilizing a chitosan-containing composition, comprising: a) opening a sealed moisture-barrier container comprising a formulation comprising the chitosan-containing composition and a desiccant, wherein the chitosan-containing composition is chosen from: a chitosan salt; a blend of (1) a solid chitosan that may be partially protonated but is greater than 80% insoluble when added to water and in a dry, free-flowing, particulate form, and (2) a solid acid or a solid agent that generates a proton in situ in the presence of water; and a chitosan derivative, and wherein the amount of desiccant is sufficient to prevent or decrease insolubilization of the chitosan-containing composition, and b) exposing the chitosan-containing composition to water to solubilize the chitosan-containing composition. The desiccant may be comprised in a desiccant-containing sachet, for example. The method may further comprise removing the desiccant-containing sachet from the moisture-resistant container after a) but before b).

Also provided is a method of desiccating a formulation comprising a chitosan-containing composition, the method comprising: sealing a formulation comprising the chitosan-containing composition and a desiccant in a moisture-barrier container, wherein the chitosan-containing composition is chosen from: a chitosan salt; a blend of (1) a solid chitosan that may be partially protonated but is greater than 80% insoluble when added to water and in a dry, free-flowing, particulate form, and (2) a solid acid or a solid agent that generates a proton in situ in the presence of water; and a chitosan derivative, and wherein the amount of desiccant is sufficient to prevent or decrease insolubilization of the chitosan-containing composition.

Further provided is a sealed moisture-barrier container comprising: a) a porous device comprising a chitosan-containing composition; and b) a desiccant. Porous devices are discussed herein. The porous device may be, e.g., a device as described in U.S. Pat. No. 6,749,748, incorporated herein by reference in its entirety. For example, the device may be a segmented body defining a multiplicity of pores, wherein the pores have an average diameter in the range of from 1 μm to 2000 μm. The device may be a porous fabric device. The moisture-barrier container may be made of mylar, for example. The desiccant may optionally be comprised in a desiccant-containing sachet. The sealed moisture-resistant container may comprise moisture content of less than 10% by weight relative to the weight of the chitosan-containing composition. In some embodiments, the desiccant is provided or comprised inside the porous device. The desiccant may be provided in a second container separate from the porous device.

The chemical mechanism to explain the insolubilization of chitosan-containing compositions when stored over time exposed to ambient temperatures and moisture, such as described in the Examples below, is not known. Without being bound by theory, the inventors suggest that the chitosan amines react with the reducing ends of the polymer chains to form Schiff bases that prevent solubilization. As such, it might be possible to prevent Schiff base formation by admixing Schiff base disruptors in the chitosan-containing compositions described herein. The Schiff base disruptors should interfere with the formation of Schiff bases between the chitosan amines and the reducing ends of the chitosan polymer chains and prevent insolubilization. One such Schiff base disruptor is sulfites. Chemicals that interfere by reacting with aldehydes or amines may be candidates. It may also be possible to admix in monosaccharide reducing sugars in excess to allow the sugar aldehydes to react with the chitosan amines (forming Schiff bases) and prevent the amines from reacting with the reducing ends of the chitosan polymer chains. It may also be possible to admix in amino-containing molecules such as ethylamine or methylamine or amino acids such as glycine or alanine, etc. It is envisioned that these amino groups would react with the reducing end aldehydes of the chitosan polymer chains and prevent their interaction with the chitosan polymer amines.

Accordingly, also provided is a formulation comprising: a) a chitosan-containing composition chosen from: a chitosan salt; a blend of (1) a solid chitosan that may be partially protonated but is greater than 80% insoluble when added to water and in a dry, free-flowing, particulate form, and (2) a solid acid or a solid agent that generates a proton in situ in the presence of water; and a chitosan derivative, and one of b), c), or d): b) a Schiff base disruptor; c) a monosaccharide reducing sugar; or d) an amine-containing substance. In some embodiments, the formulation is further defined as a chitosan-containing composition and a Schiff base disruptor. The Schiff base disruptor may be a sulfite, such as sodium bisulfite or potassium bisulfite. The formulation may be further defined as a chitosan-containing composition and a monosaccharide reducing sugar. Non-limiting examples of monosaccharide reducing sugars include glucose, mannose, galactose, fucose, glucosamine, mannosamine, and galactosamine. The formulation may be further defined as comprising a chitosan-containing composition and an amine-containing substance. The amine-containing substance may have a molecular weight of 250 g/mol or less, such as a naturally-occurring amino acid, methylamine, or ethylamine.

Also provided is a formulation comprising a chitosan-containing composition chosen from: a) a chitosan salt; b) a blend of (1) a solid chitosan that may be partially protonated but is greater than 80% insoluble when added to water and in a dry, free-flowing, particulate form, and (2) a solid acid or a solid agent that generates a proton in situ in the presence of water; and c) a chitosan derivative, wherein aldehyde moieties of the chitosan-containing composition have been reduced to alcohols. Methods pertaining to such formulations are also contemplated, such as a method of preventing or decreasing insolubilization of a chitosan-containing composition comprising: reducing aldehyde moieties of the chitosan-containing composition, wherein the chitosan-containing composition is chosen from: a) a chitosan salt; b) a blend of (1) a solid chitosan that may be partially protonated but is greater than 80% insoluble when added to water and in a dry, free-flowing, particulate form, and (2) a solid acid or a solid agent that generates a proton in situ in the presence of water; and c) a chitosan derivative, such that the degree of insolubilization of the chitosan-containing composition is prevented or decreased.

Further provided is a method for preventing or decreasing insolubilization of a chitosan-containing composition, comprising: a) reducing moisture within a container to provide a low-moisture container; b) placing a chitosan-containing composition within the low-moisture container; and c) sealing the low-moisture container. The chitosan-containing composition may be chosen from: a chitosan salt; a blend of (1) a solid chitosan that may be partially protonated but is greater than 80% insoluble when added to water and in a dry, free-flowing, particulate form, and (2) a solid acid or a solid agent that generates a proton in situ in the presence of water; and a chitosan derivative. Methods of reducing moisture include, e.g., vacuum-packaging and handling the low-moisture container in a humidity-controlled room.

Other methods include a method of preventing or decreasing insolubilization of a chitosan-containing composition, comprising: a) packaging a chitosan-containing composition in a container; and b) maintaining the composition to a temperature to maintain the water-solubility of the chitosan-containing composition when exposure to ambient temperature would otherwise result in the insolubility of the chitosan-containing composition. In some embodiments, the container comprises moisture in an amount sufficient to cause insolubility when b) is not performed. The method may comprise refrigerating the container after a) and before opening the container. As in other methods, packaging could take place using vacuum-packaging or handling the low-moisture container in a humidity-controlled room. One may maintain the temperature using refrigeration, for example.

Further provided is a sealed product containing a water-soluble chitosan-containing composition, comprising: a chitosan-containing composition chosen from: a) a chitosan salt; b) a blend of (1) a solid chitosan that may be partially protonated but is greater than 80% insoluble when added to water and in a dry, free-flowing, particulate form, and (2) a solid acid or a solid agent that generates a proton in situ in the presence of water; and c) a chitosan derivative, and a moisture content no greater than 10% by weight relative to the weight of the chitosan-containing composition. In some embodiments, the moisture content is no greater than about 1%, 2%, 3%, 4%, 5%, 6%, 7%, 8%, or 9% by weight relative to the weight of the chitosan-containing composition, or any range derivable therein.

Also provided is a chitosan-containing composition having a moisture content of less than 5% by weight relative to the chitosan-containing composition comprised in a moisture-resistant container.

Chitosan-containing compositions refer to chitosan salts, sold chitosan blends, and chitosan derivatives. In any embodiment herein, the chitosan-containing composition may be water-soluble. In any embodiment herein, the chitosan-containing composition may contain less than 5% moisture.

Chitosan Salts.

A chitosan-containing composition may be a chitosan salt (also called a chitosonium salt, a solid chitosan salt, or a sold chitosonium salt). Chitosan salts useful in the practice of the invention typically have a molecular weight in the range of from 20,000 Daltons to two million Daltons, such as from 50,000 Daltons to one million Daltons, or such as from 100,000 Daltons to 900,000 Daltons. Chitosan salts useful in the practice of the invention typically have a percentage deacetylation of from 50% to 100%, such as from 60% to 95%, or from 70%. to 90%. Some chitosan salts useful in the practice of the invention are a salt of chitosan with a C₁ to C₁₈ mono- or polycarboxylic acid, such as chitosan acetate or chitosan lactate. By way of non-limiting example, chitosan salts useful in the practice of the invention include: chitosan glutamate, chitosan hydrochloride, chitosan succinate, chitosan fumarate, chitosan adipate, chitosan glycolate, chitosan tartrate, chitosan formate, chitosan malate, chitosan citrate, and chitosan gluconate.

Solid Chitosan Blends.

Blends of solid chitosan and a solid acid or solid agent that generates a proton in situ in the presence of water may be employed in embodiments described herein. Blends are described below and, for example, in PCT/US2010/039259, incorporated herein by reference in its entirety. These blends may be combined with a desiccant, for example, or with a Schiff base disruptor.

Solid Chitosan.

Chitosan is a copolymer of 2-amino-2-deoxy-D-glucose and 2-acetoamido-2-deoxy-D-glucose units. Chitosan is commercially available from a variety of sources, and the average molecular weight range and percent deacetylation may vary. For example, solid chitosan may have an average molecular weight of between about 20,000 Da and 2,000,000 Da and may have a percent deacetylation of greater than about 50%. In some embodiments, the average molecular weight is about, at most about, or at least about 20,000, 50,000, 100,000, 150,000, 200,000, 250,000, 500,000, 750,000, 1,000,000, 1,250,000, 1,500,000, 1,750,000, or 2,000,000, or any range derivable therein. The solid chitosan may have a percent deacetylation of greater than about 50%. In some embodiments, the solid chitosan may have a percent deacetylation of about, at least about, or at most about 50%, 60%, 70%, or 80%, or more, or any range derivable therein. A solid chitosan may be partially protonated but is typically greater than about, at least about, or at most about 65%, 70%, 75%, 80%, 85%, 90%, 95%, or 99% insoluble, or any range derivable therein, when added to water and in a dry, free-flowing, particulate form. In other words, greater than a particular percentage of the solid chitosan does not dissolve. Solid chitosan employed in blends described herein is in dry, free-flowing, particulate form that excludes any solvent, such as water or an organic solvent. Solid chitosan in blends also excludes chitosan complexes. In some embodiments, chitosan may be further defined as excluding a metal, such as a chelated metal.

In some embodiments, the particle size or the average particle size of the solid chitosan ranges from about 25 microns to about 850 microns. In some embodiments, about 90% of the particles of solid chitosan in a blend range from about 25 microns to about 850 microns, or have an average particle size that ranges from about 25 microns to about 850 microns. In some embodiments, the particle size or the average particle size of the solid chitosan is greater than 850 microns. In some embodiments, the particle size or average particle size of the solid chitosan ranges from about 850 microns up to about 1 cm. In some embodiments, the particle size or average particle size ranges from about 0.5 cm to about 1 cm. Chitosan particles may be in powder or flake form, or a combination of both.

In some embodiments, the particle size of the solid chitosan is within about 20% of the particle size of the solid acid or the solid agent that generates a proton in situ in the presence of water, described below. In some embodiments, the particle size of the solid chitosan is within about, at most about, or at least about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, or 25%, or any range derivable therein, of the particle size of the solid acid or the solid agent.

Solid Acids.

Solid acids employed in blends described herein are in dry, free-flowing, particulate form. Solid acids are typically protic acids which, on dissociation, provide at least one proton (H⁺). Both mono and polyprotic (e.g., diprotic) acids may be used. The term “monoprotic” is intended to refer to an acid having one displaceable hydrogen atom per molecule. The term “polyprotic” should be construed accordingly.

Non-limiting examples of protic acids include lactic acid, adipic acid, pyruvic acid, phenyl pyruvic acid, p-hydroxyphenylpyruvic acid, p-hydroxypyruvic acid, 2-keto-glutaric acid, glyoxylic acid, α-ketoisocaproic acid, oxalacetic acid, levulinic acid, acetoacetic acid, malonaldehydric acid, glutaraldehydic acid, malonaldehydic acid, glutaraldehydic acid, p-(3-formylpropyl)benzoic acid, 3-oxovaleric acid, 2-keto-3-hydroxybutyric acid, 3-benzoylpropionic acid, 4-benzoylbenzoic acid, caprylic acid, citraconic acid, citamalic acid, citrazinic acid, hexanoic acid, n-capric acid, glutamic acid, citric acid, tartaric acid, malic acid, maleic acid, malonic acid, propionic acid, succinic acid, fumaric acid, glycolic acid, D-glucuronic acid, benzoic acid, sorbic acid, salicylic acid, galacturonic acid, ascorbic acid, glucaric acid, (meso)-galactaric acid, D-arabinaric acid, oxalic acid, benzoic acid, sulphanilic acid, gluconic acid, palmitic acid, stearic acid, ethylene diamine tetraacetic acid, glucoheptonic acid, nicotinic acid, oleic acid, phytic acid, polygalacturonic acid, sulfamic acid, uric acid, carminic acid, L-pyroglutamic acid, D-pyroglutamic acid, amino benzoic acid, 6-amino caproic acid, glutaric acid, dodecylbenzene sulfonic acid, octanoic acid, glyoxylic acid, isovaleric acid, boric acid, mercaptoacetic acid, aspartic acid, alanine, arginine, asparagine, cysteine, glutamine, glycine, histidine, isoleucine, leucine, lysine, methionine, phenylalanine, proline, serine, threonine, tryptophan, tyrosine, valine, sodium diacetate and potassium diacetate. In some embodiments, the solid acid is malic acid, citric acid, tartaric acid, sodium diacetate (a combination of acetic acid and sodium acetate), or potassium diacetate (a combination of acetic acid and potassium acetate). Any blend described herein may comprise sodium acetate. The acetate ion may aid in chitosan solubility. It is understood that liquid acids can be made into solid forms, i.e., solid lactic acid is commercially available in a solid form.

The corresponding solid salts of solid acids listed above may also be incorporated into the blends in combination with their respective solid acids or different solid acids.

Solid Agents.

Solid agents that generate a proton in situ in the presence of water may also be employed (e.g., the solid agent provides at least one proton when dissolved in water). With regard to solid agents that generate a proton in situ in the presence of water, sulfite salts, organic acid lactones, organic acid anhydrides are contemplated.

Sulfite salts may be used because they form sulfurous acid when dissolved in water.

Acid salts may be employed in blends, such as sodium bisulfate, sodium diacetate, sodium sesquicarbonate, or dicalcium citrate.

Organic acid lactones can also be used to formulate blends of solid chitosan. The lactones undergo hydrolysis in water and produce the corresponding organic acid in situ. The hydrolysis rate of organic acid lactones into the corresponding acid can vary between different organic acid lactones. The in situ generation of the acid in an aqueous medium can likely influence the solubility profile of chitosan and may be very different compared to the solubility profile of the chitosan contained in the solid corresponding solid acid-solid chitosan blend. This is one way to control the solubilization rate of the chitosan. Examples of organic acid lactones include glucuronic acid lactone, D-glucono-1,4-lactone, gluconic acid lactone, galacturonic acid lactone, mannuronic acid lactone, glyconic acid lactone, D-glucofuranurono-6,3-lactone, and D-galactopyranurono-6,3-lactone.

Solid organic acid anhydrides can also be used in the blends of solid chitosan. The solid organic acid anhydrides undergo hydrolysis in water and produce the corresponding organic acid in situ. The hydrolysis rate of solid organic acid anhydrides into the corresponding acids can vary between different organic acid lactones. The in situ generation of the acid in an aqueous medium can likely influence the solubility profile of chitosan and may be very different compared to the solubility profile of the chitosan contained in the solid corresponding acid-solid chitosan blend. This is one way to control the solubilization rate of the chitosan. Non-limiting examples include succinic anhydride, maleic anhydride, malic anhydride, and citraconic anhydride.

It has also been demonstrated that derivatization of chitosan by the reaction of the anhydride in an aqueous medium such as water is possible. The resulting chitosan derivative is no longer cationic, but exhibits anionic properties due to covalent attachment of carboxyl functional groups derived from the anhydride, such as from succinylation with succinic anhydride. It is envisioned that a solid acid-solid chitosan blend containing the corresponding or different organic acid anhydride can result in formation of chitosan derivatives in situ that contain both cationic and anionic properties attributed to covalently bound carboxyl functions and protonated primary amines. The nature and properties of the chitosan derivative can be influenced and controlled by the ratio of solid acid to chitosan and the ratio of solid organic acid anhydride. It also envisioned that by controlling the ratio of organic acid anhydride added to solid chitosan in an organic acid anhydride blend without the addition of an added solid organic acid, the normal cationic chitosan could be converted into an anionic chitosan in situ.

Further Information Regarding Solid Acids and Solid Agents.

In some embodiments, the solid acid is not hyaluronic acid, nicotinic acid (see U.S. Pat. No. 5,736,532), a fatty acid, a nucleic acid, lactic acid (see U.S. Publ. Appl. No. 2005/0239657), or succinic acid (see U.S. Publ. Appl. No. 2005/0239657). In some embodiments, the solid acid is not a non-phytotoxic acid, such as arginine, histidine, isoleucine, leucine, lysine, methionine, phenylalanine, threonine, tryptophan, valine, alanine, aspartic acid, citrulline, cystine, glutamic acid, glycine, hydroxyglutamic acid, norleucine, proline, serine, and tyrosine, adipic acid, hydrochloric acid, tartaric acid, nitric acid, formic acid, or citric acid (see U.S. Pat. No. 4,964,894).

In some embodiments, the solid acid or solid agent that generates a proton in situ in the presence of water is not a polymer (see WO 2010/023463). In some embodiments, the solid acid is not glyoxylic acid (see WO 2008/087845). In some embodiments, the solid acid is not ascorbic acid (see WO 00/024785).

In some embodiments, the particle size or the average particle size of the solid acid or solid agent ranges from about 25 microns to about 850 microns. In some embodiments, about 90% of the particles of solid acid or solid agent in a blend range from about 25 microns to about 850 microns, or have an average particle size that ranges from about 25 microns to about 850 microns. In some embodiments, the particle size or the average particle size of the solid acid or solid agent is greater than 850 microns. In some embodiments, the particle size or average particle size of the solid acid or agent ranges from about 850 microns up to about 1 cm. In some embodiments, the particle size or average particle size of the solid acid or solid agent is less than the solid chitosan particle size or average particle size. In some embodiments, the particle size or average particle size of the solid acid or solid agent is greater than the solid chitosan particle size or average particle size.

The ratio of a solid chitosan to a solid acid or solid agent that generates a proton in situ in the presence of water may vary. In some embodiments, the ratio of the solid chitosan to the solid acid or the solid agent that generates a proton in situ in the presence of water ranges from about 1:10 to about 10:1 (wt./wt.). In other embodiments, the ratio of solid chitosan to the solid acid or the solid agent that generates a proton in situ in the presence of water is about 1:1 (wt./wt.). In yet other embodiments, the ratio of solid chitosan to the solid acid or the solid agent that generates a proton in situ in the presence of water is about 1:2 (wt./wt.).

Blends.

Blends refer to any combination of a solid chitosan and one or more of the solid acids or agents discussed herein, and may optionally comprise additional components, as explained herein. Blends of a solid chitosan and a solid acid or a solid agent that generates an acid in situ in the presence of water refer to mixtures or formulations of dry, free-flowing, particulates of each component. The solid chitosan and the solid acid or the solid agent are not reacted together or otherwise chemically bound while in the blended condition. That is, the solid chitosan and the solid acid or the solid agent are chemically separate from each other. For example, the solid chitosan and the solid acid or the solid agent are not covalently bound together, do not form a complex, and are not cross-linked together, nor does one component “cage” the other component.

Blends may comprise, consist essentially of, or consist of a solid chitosan and a solid acid or a solid agent that generates an acid in situ in the presence of water. In some embodiments, the only two components of the blend are a solid chitosan and a solid acid or a solid agent. In blends consisting essentially of a solid chitosan and a solid acid or a solid agent, the blend excludes components that do not materially affect the novel and basic characteristics of the solid chitosan and the solid acid or the solid agent. For example, a blend consisting essentially of a solid chitosan and a solid acid or a solid agent may exclude water and organic solvents. It is specifically contemplated that a blend may comprise, consist essentially of, or consist of a solid chitosan, a solid acid, and a solid agent. Trace amount of impurities may be present in blends. Impurities may include, for example, digested proteinaceous material from the processing of chitin into chitosan, or mineral salts such as potassium or calcium carbonate or potassium or calcium phosphate.

Blends comprising a solid chitosan and a solid acid or a solid agent may, in some embodiments, be further defined as not comprised in a film, coating, or tablet. In some embodiments, the blend is not in layer form. In some embodiments, the blend is not comprised in a hydrogel. In some embodiments, a blend does not comprise, nor is comprised in, a slurry, a liquid, or a solution. In some embodiments, carbonates or bicarbonates are excluded from a blend (see U.S. Publ. Appl. No. 2008/0190861). In some embodiments, drugs are excluded from a blend (see U.S. Publ. Appl. No. 2006/0115525).

Different ratios of solid chitosan to solid acid or solid agent are possible on a weight or molar equivalent basis. This ratio would depend on the type of solid acid or solid agent used and the molecular weight and the degree of deacetylation of the solid chitosan. In some embodiments, the ratio of solid chitosan to solid acid or solid agent ranges from about 1:10 to about 10:1. In some embodiments, the ratio is about, at least about, or at most about 1:10, 1:5, 3:10, 2:5, 1:2, 3:5, 7:10, 4:5, 9:10, 1:1, 10:9, 5:4, 10:7, 5:3, 2:1, 5:2, 10:3, 5:1, or 10:1, or any range derivable therein.

The particle size range of the solid chitosan and the particle size range of the solid acid or solid agent in a blend may vary, such as described above. It is expected that there would be an optimum particle size range for both the solid chitosan and the solid acid or solid agent. For example, particles of solid chitosan that are less than 850 microns, such as ranging from about 25 to about 850 microns, can be effectively blended with solid acids exhibiting particle sizes that range in size from table salt and granulated refined sugar to powders. Larger particle sizes of solid acids and solid agents may also be used. In some embodiments, about 90% of the solid chitosan in a blend has a particle size of about 25 microns to about 850 microns. It is expected that particle sizes of chitosan greater than about 850 microns would also be effectively blended with solid acids or solid agents of a similar size range, or larger or smaller size range. In some embodiments, the particle size of the solid chitosan is within about, at most about, or at least about 10%, 20%, 30%, 40%, 50%, 60%, 70%, 70%, 80%, or 90% of the particle size of the solid acid or the solid agent, or any range derivable therein.

When particle sizes are comparable in size, the chance of settlement of larger particles is minimized. It is typically easier to alter the particle size of the solid chitosan, which is typically in particle or flake form, to approach the size of the solid acid or solid agent, rather than vice versa. For example, coarse-ground chitosan, which is typically between about 0.25 cm to about 0.5 cm, may be further ground to approach the particle size of a solid acid or solid agent, which may be more of a powder. However, blends having differing particle sizes are also possible. For example, if solid chitosan particles and solid acid or solid agent particles are disparate in size (e.g., a 1 cm solid chitosan flake and a powdered solid acid), a packaging including a blend of both types of particles may be used, wherein the blend is poured into water, such that any settlement of the particles that occurred prior to exposure to water does not matter.

Additional Components.

In some embodiments, a blend containing solid chitosan and a solid acid or solid agent may comprise one or more additional components. Combinations of the following components are also contemplated. Typically, an additional component will be in a solid, dry, free-flowing, particulate form. However, embodiments contemplate blends containing glycerin to enhance the solubility of the solid chitosan.

Other embodiments include solid chitosan blended with combinations of solid acids together with solid salts of organic acids, wherein each salt is in a dry, free-flowing, particulate form. Examples include solid chitosan blended with lactic acid and calcium lactate; chitosan blended with lactic acid, calcium lactate in combination with sodium acetate; chitosan blended with adipic acid in combination with sodium or potassium acetate; chitosan blended with adipic acid in combination with sodium or potassium hexanoate; chitosan blended with glutamic acid in combination with sodium or potassium acetate; chitosan blended with glutamic acid in combination with sodium or potassium hexanoate; chitosan blended with solid adipic acid in combination with solid benzoic acid. A blend may comprise solid chitosan with sodium diacetate that may optionally include a solid salt of an organic acid. These examples are not meant to be exhaustive but merely to provide examples of the types and possible varieties of combinations that are possible. These blends may act to influence chitosan's solubility properties and provide benefits in certain applications.

Another embodiment contemplates blends containing solid preservative acids or solid salts of preservative acids or solid antimicrobial agents that retard or prevent the growth of microorganisms such as molds, yeasts, fungi, and bacteria in the wetted blend. Such components are in a dry, free-flowing, particulate form. Non-limiting examples of solid preservative acids include benzoic acid, propionic acid, sorbic acid, or solid salts of these acids blended with solid acids such as glutamic acid, citric acid, adipic acid, tartaric acid, etc. Non-limiting examples of solid antimicrobial agents include parabens and methylparabens, sulfite salts, sodium and potassium sulfite, sodium or potassium metabisulfite, zinc salts, pyrithiones, essential oils, etc.

Another embodiment contemplates blends containing a solid metal salt that is in a dry, free-flowing, particulate form. Non-limiting examples of solid metal salts include lanthanum chloride, lanthanum oxide, lanthanum acetate, zirconium acetate, zirconium oxychloride, aluminum sulfate, aluminum chloride, ferric chloride, ferric sulfate, ferrous sulfate, sodium aluminate, copper as (FeSO₄.7H₂O), and iron salts.

Another embodiment contemplates blends containing solid, neutral (non-ionic) polysaccharides in a dry, free-flowing, particulate form that are typically water-soluble. Non-limiting examples include guar, starch, glucomannans, glucans, methylcellulose, hydroxypropylcellulose, hydroxypropylmethylcellulose, galactomannans, mannans, xyloglucans. These blends can also contain solid metal salts to aid in coagulation or flocculation and removal of impurities in water.

Another embodiment contemplates blends containing solid anionic polysaccharides in a dry, free-flowing, particulate form that are typically water-soluble. Non-limiting examples include agars, carrageenans, xanthans, polygalacturonates, pectins, alginates, gellans, dextran sulfate, and carboxymethylcellulose.

Blends may also comprise solid cationic polysaccharides in a dry, free-flowing, particulate form that are typically water-soluble. Non-limiting examples include cationic guars or cationic starches.

Blends may comprise solid organic or inorganic amines in a dry, free-flowing, particulate form. Non-limiting examples include diallyl-dimethyl ammonium chloride, dimethylamine, dimethylaminoethyl-methacrylate, ethanolamine, methylamine, and triethylamine.

It is envisioned that solid metal salts or solid organic amines can be used in various combinations with solid cationic polysaccharides alone, solid neutral polysaccharides alone, or solid anionic polysaccharides alone. For example, a solid cationic polysaccharide may be combined in a blend with a solid metal salt or a solid organic amine, wherein each component is in a dry, free-flowing, particulate form. Alternatively, a solid, anionic polysaccharide may be combined in a blend with solid chitosan, a solid acid, and a solid metal salt, wherein each component is in a dry, free-flowing, particulate form. As another alternative, a solid neutral polysaccharide may be combined in a blend with a solid metal salt or a solid organic amine, a solid chitosan, and a solid metal acid, wherein each component is in a dry, free-flowing, particulate form.

In some embodiments, a composition comprises a blend of: a solid chitosan that may be partially protonated but is greater than 80% insoluble when added to water and in a dry, free-flowing, particulate form, and solid sodium diacetate or solid potassium diacetate, or a combination thereof, that is in a dry, free-flowing, particulate form, wherein the solid chitosan and the solid sodium diacetate or solid potassium diacetate, or combination thereof, are not reacted together or otherwise chemically bound. The ratio of solid chitosan to solid sodium diacetate or sodium potassium diacetate may range from about 1:1 to about 1:5 (wt./wt.). In some embodiments, the ratio ranges from about 1:2 to about 1:3 (wt./wt.). In compositions comprising a blend of a solid chitosan and solid sodium diacetate or solid potassium diacetate, the particle size of each may be any particle size or average particle size described herein. In some embodiments, the particle size or the average particle size of the solid chitosan and solid sodium diacetate or solid potassium diacetate are each about 25 microns to about 850 microns. In some embodiments, about 90% of the solid chitosan or the solid sodium diacetate or solid potassium diacetate ranges from about 25 microns to about 850 microns.

Chitosan Derivatives.

Solid chitosan derivatives refer to covalently modified chitosan. Chitosan may be covalently modified at an oxygen atom, a nitrogen atom, or a combination of both in order to produce a solid chitosan derivative. In some embodiments, a chitosan derivative is defined as chitosan covalently modified to exhibit carboxyl functionality (e.g., succinyl chitosan). In some embodiments, a chitosan derivative is only partially derivatized, such as a chitosan derivative having only about 50% of its amino groups covalently modified. Chitosan derivatives may be employed by themselves or in a blend, described above. Non-limiting examples of chitosan derivatives include succinyl chitosan and glycol chitosan.

Desiccants.

Embodiments described herein may employ a desiccant. In some embodiments, the amount of desiccant is sufficient to substantially reduce the amount of water present in a formulation comprising a chitosan-containing composition, or present in packaging or a container comprising such a formulation. For example, the amount may be sufficient to reduce the amount of water present to less than 10%, by weight relative to the weight of the chitosan-containing composition. In some embodiments, the amount of water reduced is about, at most about, or at least about 0%, 1%, 2%, 3%, 4%, 5%, 6%, 7%, 8%, or 9% by weight relative to the weight of the chitosan-containing composition, or any range derivable therein. It is not necessary that a desiccant remove all water. The amount of desiccant used will typically depend on the type of desiccant. Non-limiting types of desiccants include molecular sieves, silica gel, montmorillonite clay, indicating silica gel, calcium oxide, calcium sulfate, and activated alumina.

Devices.

Devices may be employed that contain compositions described herein such that solubilized chitosan is released into water surrounding part or all of the device. Such devices are porous, wherein the pores allow water to enter and hydrate the composition, dissolving the solid chitosan and releasing soluble chitosan through the pores into the aqueous medium outside of the device. The pore size and quantity or configuration of the device can be made in a way to influence the release of the soluble chitosan. A delivery device may be a porous fabric (e.g., a porous “sock”) or metal or plastic container. The delivery device may be a woven or non-woven porous material.

Another embodiment contemplates compositions contained within a device for controlling the rate of release or dose of chitosan. The rate of solubilization and release of soluble chitosan can be controlled by, for example, the solubility of the acid chosen when employing a solid chitosan/solid acid blend. It is envisioned that a fast dissolving blend containing a solid chitosan and a solid acid or solid agent would be advantageous for certain waters containing impurities that need to be removed more rapidly. This could be due to a higher amount of impurities in the water requiring a higher dose rate of dissolved chitosan. The porous device may be, for example, a segmented fabric sock. The sock may be exposed to running water, wherein a blend comprised in the sock dissolves. Non-limiting examples of devices are set forth in U.S. Pat. Nos. 6,749,748 and 6,821,427, each of which is incorporated herein by reference in their entirety.

In one aspect, the present invention provides a device for reducing the amount of contaminants in water, each device comprising a composition as described herein disposed within a body defining a multiplicity of pores, wherein the pores may have an average diameter in the range of from 1 μm to 2000 μm. U.S. Pat. No. 6,749,748, incorporated herein by reference in its entirety, discloses a suitable device.

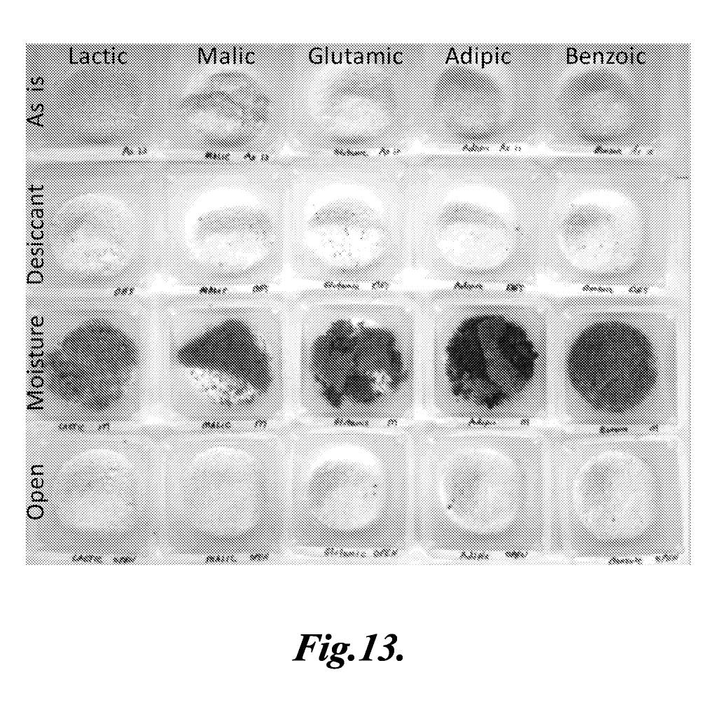

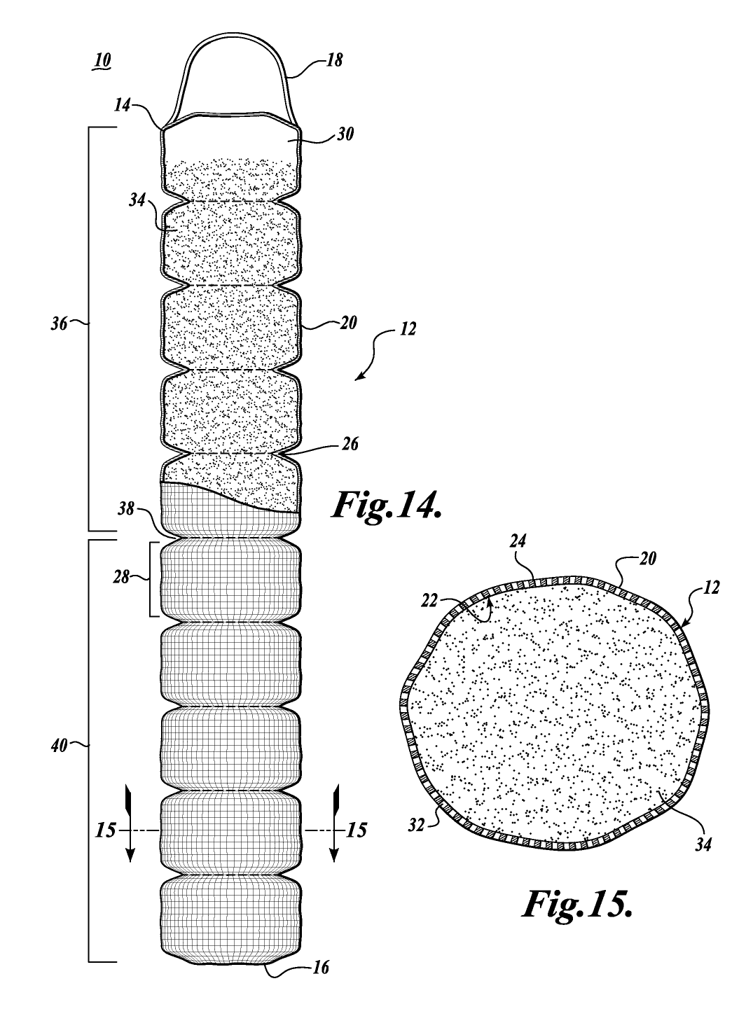

For example, FIG. 14 shows one embodiment of a device 10 of the present invention, which includes a body 12 that has a first end 14 and a second end 16, and a handle 18 attached to body first end 14. As shown more clearly in the cross-section of device 10 shown in FIG. 15, body 12 includes a body wall 20 defining an inner surface 22 and an outer surface 24. Again with reference to FIG. 14, body wall 20 includes stitching 26, perpendicular to the long axis of body 12, at regularly spaced intervals along its length that divide body wall 20 into segments 28. Each segment 28 defines a lumen 30. Body wall 20 is penetrated by a multiplicity of pores 32 (shown more clearly in FIG. 15) that connect body inner surface 22 and body outer surface 24.

A composition 34 is disposed within lumen 30 of each segment 28. In the embodiment shown in FIG. 14, lumen 30 closest to first end 14 is only partially filled with composition 34 in order to more clearly show lumen 30. Each segment 28 can include the same or different composition 34 as one or more of the other segments 28. The embodiment of device 10 shown in FIG. 14 is flexible. Flexibility is facilitated by the segmentation of body 12. Device body 12 includes a first half 36, extending from body first end 14 to body midpoint 38, and a second half 40, extending from body midpoint 38 to body second end 16. Other embodiments may omit segmentation.

In operation, device 10 is at least partially immersed in moving water that contains one or more contaminants. The water penetrates pores 32 and contacts composition 34 which begins to dissolve. Dissolved composition 34 leaves lumen 30 through pores 32 and forms insoluble complexes with contaminants in the water (although the formation of insoluble complexes can begin at the moment that composition 34 is dissolved by the water).

Although the embodiment of device 10 shown in FIG. 14 has a generally cylindrical (although segmented) shape when filled with composition 34, device 10 can be any shape that is adapted for use in a particular application. Device body 12 can be made from any material that is sufficiently strong to retain composition 34 and to resist the forces exerted by water moving over device 10, and which is sufficiently porous to allow water to penetrate device 10 to contact composition 34 within lumen 30, although pores 32 should not be so large that they permit rapid escape and dissolution of composition 34. Some embodiments of device body 12 are stretchable. Device 10 can optionally include an attachment means, such as handle 18, that is attached to device body 12 and which is used to attach device 10 to a support, such as to a metal or plastic pipe when device 10 is disposed therein.

Moisture-Resistant Containers.

Moisture-resistant containers comprise, at a minimum, a chitosan-containing composition. Moisture-resistant containers that may be employed herein are those that, upon sealing or closure, prevent ingress of moisture such that the solubility of the chitosan-containing composition comprised within the container is maintained until used. The materials may completely bar ingress of moisture or may permit moisture ingress at a rate that does not detrimentally affect the solubilization of the chitosan-containing composition comprised within over a desired period of time (e.g., during storage or shipping). The more moisture that permeates the container, the more desiccant needs to be used to prevent or decrease insolubilization of the chitosan-containing composition.

Non-limiting examples of moisture-resistant materials include aluminized plastic (e.g., mylar), plastic, foil, laminated paper or cardboard, and polyethylene (see, e.g., U.S. Pat. No. 6,770,712, incorporated herein by reference in its entirety). Moisture-resistance of a material may be assessed by measuring the amount of moisture absorption of the material itself over time. For example, ASTM D-570-63 provides a standardized test for determining moisture absorption. Mylar is an example of a moisture-resistant material that can constitute a moisture-resistant container, and mylar absorbs less than 0.8% moisture when totally immersed for 24 hours using this standardized test. Other materials that behave similarly (e.g., absorb less than 1.5% moisture using this test) may be employed. Moisture-resistant containers may be sealed using any method known in the art, such as heat-sealing, moisture-resistant tape, or other moisture-resistant adhesive. Moisture-resistant containers can be used in the context of vacuum-packaging or refrigeration, in some embodiments.

A moisture-resistant container may comprise a chitosan-containing composition and a desiccant. The desiccant may be blended with the chitosan-containing composition, or it may be physically separated from the chitosan-containing composition. If the desiccant is blended with the chitosan-containing composition, the entire admixture may be exposed to water when solubilization of the chitosan-containing composition is desired. Or, the desiccant may be removed by, for example, filtering or sifting before or after solubilization. Alternatively, the desiccant may be comprised in a separate packaging, such as a sachet. Upon opening the moisture-resistant container comprising the chitosan-containing composition and the desiccant-containing sachet, the sachet could be removed prior to exposing the chitosan-containing composition to water for solubilization.

In some embodiments, a chitosan-containing composition that contains less than 5% moisture by weight relative to the weight of the chitosan-containing composition is placed in a container. For example, moisture could be removed from the chitosan-containing composition using drying (e.g., heat, vacuum, desiccant), and placed in a container which may or may not be a moisture-resistant container. The chitosan-containing composition may then be later placed in a fabric sock, such as a Gel-Floc™ sock, and the sock then placed in another container, such as a moisture-resistant container, with or without a desiccant.

Use of solids herein that are in a dry, free-flowing, particulate form refer to solids that behave much like sand flowing from one portion of an hourglass to another. Use of the word “solid” is intended to exclude other states of matter such as liquids and gases.

In some embodiments, flocculation or precipitation of matter in the water is induced after soluble chitosan is released into the water. As used herein, “flocculation” refers to a process of contact and adhesion whereby particles of a dispersion form larger-size clusters. As used herein, flocculation is synonymous with coagulation. As used herein, “precipitation” refers to the sedimentation of a solid material from a liquid solution. The matter may be organic matter. The matter may be selected from the group consisting of particles, sediment, suspended matter, and dissolved substances. The water may be moving water, stream water, or stormwater, or any other water described herein.

Methods of determining solubility of chitosan are well-known in the art. One may determine solubility by, for example, weighing a sample of solid chitosan and correcting for moisture, form a solution with dilute acid, filter the solution through tared filter paper and collect insoluble material on the tared filter paper, dry and weigh the paper, and then calculate the percent of material that did not dissolve.

Some embodiments herein apply to treating stormwater, industrial water, recreational water, environmental water, production water, frac water, grey water, bilge water, drinking water, irrigation water or any other aqueous solution that requires the solubility of the chitosan, chitosan salt, or chitosan derivative in order to clarify or remove an insoluble or soluble component contained within the aqueous solution. The dissolved chitosan salt, solid chitosan or chitosan derivative may function by aggregating, floccing, or precipitating a particulate or soluble material such that the aggregated, flocced, or precipitated particulate can be removed from the aqueous solution by filtration, sedimentation, settling, centrifugation, dissolved air flotation, skimming, and the like. Water may be comprised in a vessel, stream, river, lake, or other body of water.

Any embodiment herein may employ vacuum-packaging (also called vacuum-packing) of a moisture-resistant container comprising a chitosan-containing composition, refrigeration of a moisture-resistant container comprising a chitosan-containing composition, or use of a humidity-controlled room during handling or packaging of chitosan-containing compositions, or combinations of vacuum-packaging, refrigeration, or humidity-controlled room usage. In some embodiments, vacuum-packing is performed to provide a moisture content of less than 2% by weight of the chitosan-containing composition in a container or packaging. In some embodiments, such methods may employ chitosan-containing compositions to the exclusion of a desiccant because such methods may provide sufficient prevention of insolubilization of a chitosan-containing composition without the need for a desiccant.

Also provided is a product, comprising: a container; and a chitosan-containing composition in the container; wherein a means for removing the moisture from the container is included in or performed on the container. In some embodiments, the means may be a desiccant, vacuum-packaging, and packaging in a humidity-controlled atmosphere or low-moisture atmosphere. Further provided is a vacuum-packed product, comprising a chitosan-containing composition. A vacuum-packed product may consist essentially of a chitosan-containing composition, where such a product excludes materials that do not materially affect the basic and novel characteristics of the product, such as materials that impede solubilization of the chitosan-containing composition (e.g., hygroscopic materials). A vacuum-packed product may consist of a chitosan-containing composition, wherein the chitosan-containing composition is the only item inside the vacuum-packed product.

When discussing moisture content by weight, it is intended that the moisture content is relative to the weight of the chitosan-containing composition, unless otherwise noted.

Methods may comprise steps described herein, or may consist of only of such steps, to the exclusion of any other steps. Methods may alternatively consist essentially of steps described herein. Methods consisting essentially of steps are methods that exclude components or steps that do not materially affect the novel and basic characteristics of the method or its effects.

It is specifically contemplated that any limitation discussed with respect to one embodiment of the invention may apply to any other embodiment of the invention. Furthermore, any composition of the invention may be used in any method of the invention, and any method of the invention may be used to produce or to utilize any composition of the invention.

The use of the term “or” in the claims is used to mean “and/or” unless explicitly indicated to refer to alternatives only or the alternative are mutually exclusive, although the disclosure supports a definition that refers to only alternatives and “and/or.”

Throughout this application, the term “about” is used to indicate that a value includes the standard deviation of error for the device or method being employed to determine the value. In any embodiment discussed in the context of a numerical value used in conjunction with the term “about,” it is specifically contemplated that the term “about” can be omitted.

As used herein the specification, “a” or “an” may mean one or more, unless clearly indicated otherwise. As used herein in the claim(s), when used in conjunction with the word “comprising,” the words “a” or “an” may mean one or more than one. As used herein “another” may mean at least a second or more.

### EXAMPLES

### Example 1

### Sachet Assay and Conical Tube/Screen Assay

A Sachet Assay and a Conical Tube/Screen Assay were used for testing properties of chitosan lactate. These Assays may be used with any chitosan-containing composition described herein.

Chitosan Lactate.

Chitosan lactate salt may be obtained in a variety of ways. For example, one may dissolve solid chitosan in an aqueous solution of lactic acid and then dry the solution by spray-drying, lyophilizing, or refractive index drying. These methods may be employed to generate other chitosan salts as well.

Sachet Assay.

In a Sachet Assay, sachets were made with the same fabric as found in Gel-Floc™ socks. Chitosan lactate salt samples were placed in the fabric sachets and sewn closed on all four sides. Both sachets were filled with 4 grams of the chitosan salt and placed in deionized water in a beaker and stirred rapidly for 42 hours at room temperature. At 19 hours the sachets were removed, weighed, and photographed. A visual determination was made as to whether the chitosan lactate dissolved or swelled over time. For example, the outside of each sachet was examined for a surface viscosity difference from water by touch and feel. A sachet exhibiting a slimy layer on the exterior indicated the lack of solubility of the chitosan lactate and release of the chitosan biopolymer from the sachet. The sachets were also cut open and examined to determine if the sachet contained highly viscous soluble chitosan lactate or gelled particles of chitosan lactate exhibiting the characteristics of Jello® or hydrated tapioca.

Each sachet was weighed at various time points to assess absorption of water and increase in weight. For example, within 2 hours, sachets having a soluble or insoluble chitosan lactate typically absorbed water and increased in weight. After 2 hours, however, properly functioning sachets released chitosan lactate over time resulting in decreasing weight over 42 hours. In contrast, dysfunctional sachets continued to absorb water over time as evidenced by increased swelling of the sachet with a corresponding increase and final plateau in weight.

Conical Tube/Screen Assay.

In the Conical Tube/Screen Assay, 0.50 grams of a chitosan lactate salt sample was placed in a 50 ml plastic centrifuge tube. Deionized water (45 ml) was added and the tube capped and inverted 5× and allowed to sit at room temperature for a period of 4 hrs. During this time, the tubes were inverted with the bottom facing up at a 45 degree angle. The tube was rapidly mixed by flicking against fingers of one hand for 10 seconds and the tubes were inverted again 5× and placed upright in their holders until the next time interval. This action was performed every ½ hour. After 4 hours, the tubes were inverted 5× and scored visually for solubility on a scale of 1-3 (1—most soluble, 2—partially soluble, 3—insoluble) and recorded as a Visual Solubility Score.

The tubes were then shaken vigorously and poured into a small tared kitchen strainer mounted on a 300 ml beaker. The soluble chitosan lactate salt flowed through the strainer and any gels or insoluble chitosan lactate salt flakes were trapped on the strainer screen. The strainer containing the gels or insoluble chitosan lactate flake was weighed and subtracted from the tare weight and recorded as sample wt. The sample weight was divided by the original dry weight (0.50 g) and this number (Swell Value) was multiplied by the Visual Solubility Score. The resulting calculation provided an Insolubility Score. The larger the Insolubility Score, the more insoluble the chitosan lactate. Chitosan lactate salts exhibiting large values (>˜25) tend to swell and increase in weight due to poor release properties of the chitosan lactate salt over time. Chitosan lactate salts with larger Insolubility Scores (>40) tend to exhibit significantly more gels and exhibit very poor release properties concomitant with a large increase in swelling of the sachets. Chitosan lactate salts exhibiting low values (<20 with Visual Solubility Scores of 1 or 2) tend to decrease in weight (following an initial weight increase as the chitosan lactate salt becomes hydrated), corresponding to a decrease in sachet swelling, thus demonstrating proper release performance properties. Chitosan lactate salts exhibiting Insolubility Scores <20 with a Visual Solubility Score of 3 (typical of rigid insoluble flakes) are non-performers and tend to exhibit some swelling but not release from the sachet.

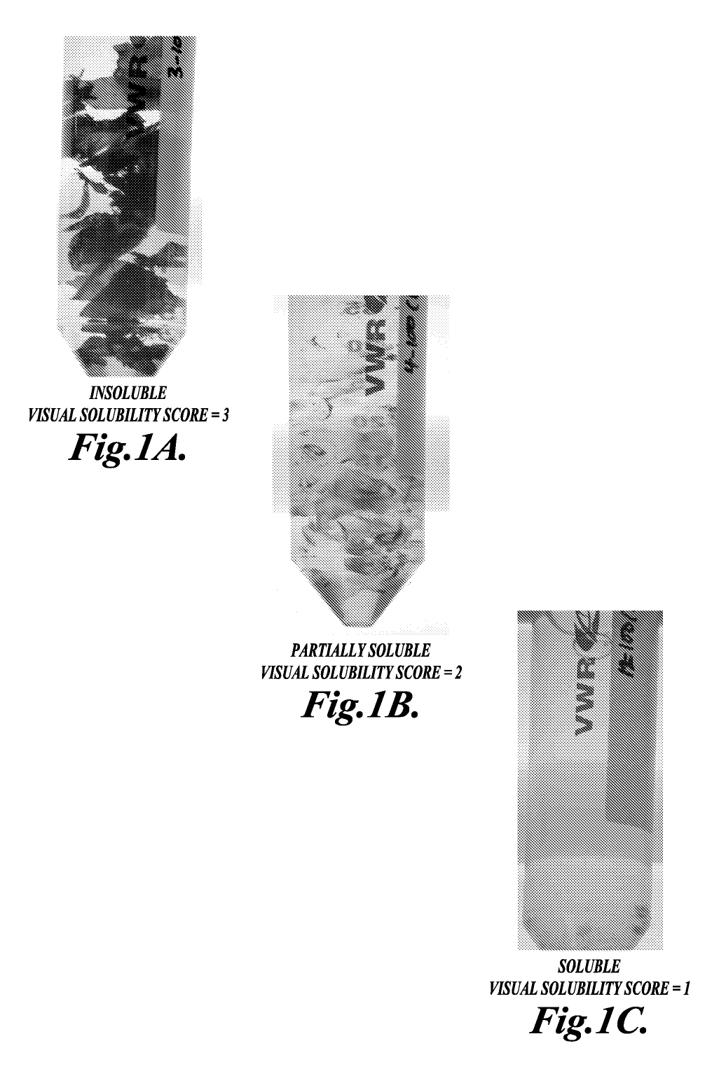

An example of what a visual evaluation looks like for determining a Visual Solubility Score is shown in FIGS. 1A, 1B, and 1C. The conical tubes contain chitosan lactate salts with different solubilities. A highly insoluble chitosan lactate salt is seen in FIG. 1A. This chitosan lactate salt was exposed to a high temperature while sealed in a mylar bag. The chitosan appears charred and is no longer soluble and is ranked a 3. The swelling properties of FIG. 1A's sample are minimal compared to FIG. 1B and FIG. 1C but it does not dissolve and release chitosan lactate from a sachet made of fabric found in a Gel-Floc™ device as described in the Sachet Assay above. The chitosan lactate in FIG. 1B was also heated while sealed in mylar, but the mylar bag also contained a small amount of desiccant. The desiccant mitigated much of the charring compared to the control and the chitosan lactate salt exhibited limited solubility over time and swelling was observed in a sachet. This type of mixed soluble/insoluble observation is typically given a Visual Solubility Score of 2. The chitosan lactate contained in FIG. 1C exhibited good solubility as evidenced by a clear viscous solution and is typically scored a 1. Chitosan lactate salts exhibiting this type of visual solubility property perform quite well in the Sachet Assay described above.

### Example 2

### Screen Insolubles

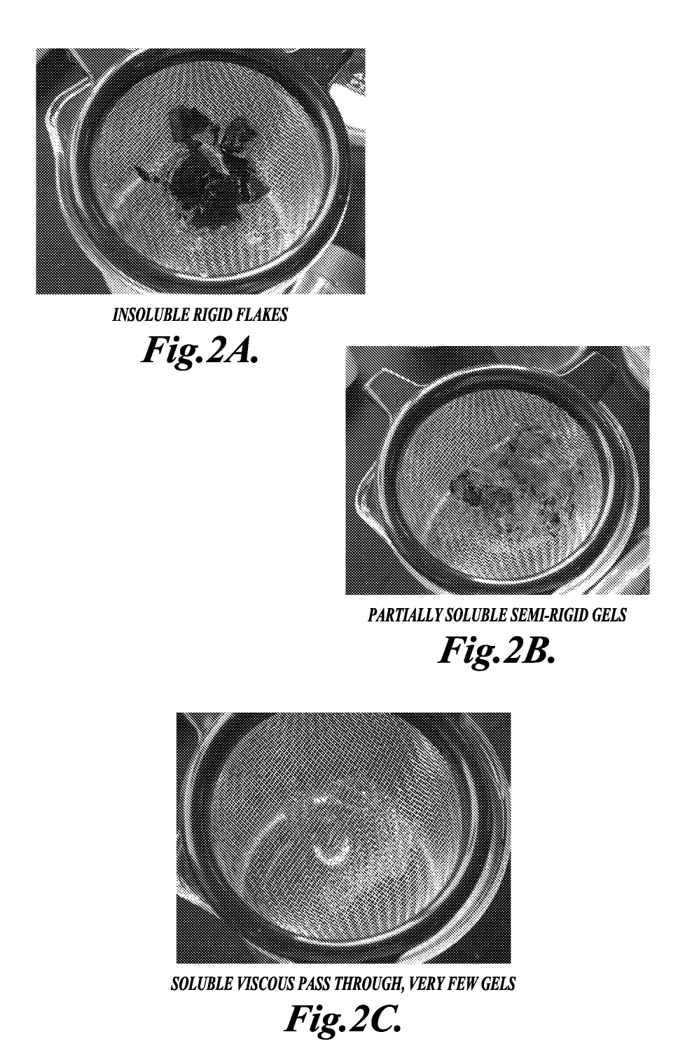

Once a Visual Solubility Score is obtained using the procedure of Example 1, solution samples of chitosan lactates contained in the tubes are then poured directly onto tared kitchen strainers allowing any soluble chitosan lactate to pass through and any insoluble or gelled chitosan lactate to collect on the screen where it can be quantitated. “Insoluble” chitosan lactate salt flakes are more rigid and not as hydrated or gelled compared to “partially soluble” chitosan lactate salts. See FIGS. 2A, 2B, and 2C for a comparison of “insoluble,” “partially soluble,” and “soluble” chitosan lactate salts. The “insoluble” flakes exhibit characteristics of an insoluble low-swellable solid that is limited in its ability to expand and hydrate as water is absorbed. On the other hand, “partially soluble” chitosan lactate salts exhibit properties much like a superadsorbent polymer. This type of gel is easily hydrated and expands to hold significant amounts of water relative to its own weight which explains the higher swell value. Both types still expand in sachets and are limited in their ability to release soluble chitosan lactate salts through the sachet or Gel-Floc™ sock geotextile fabric. This property has a negative impact on sediment or suspended particulate performance. “Soluble” chitosan lactate salts leave very little gels, if any, on the screen and perform quite well in Sachet Assays. They behave more as solutions rather than gels and are easily released through the fabric into the water.

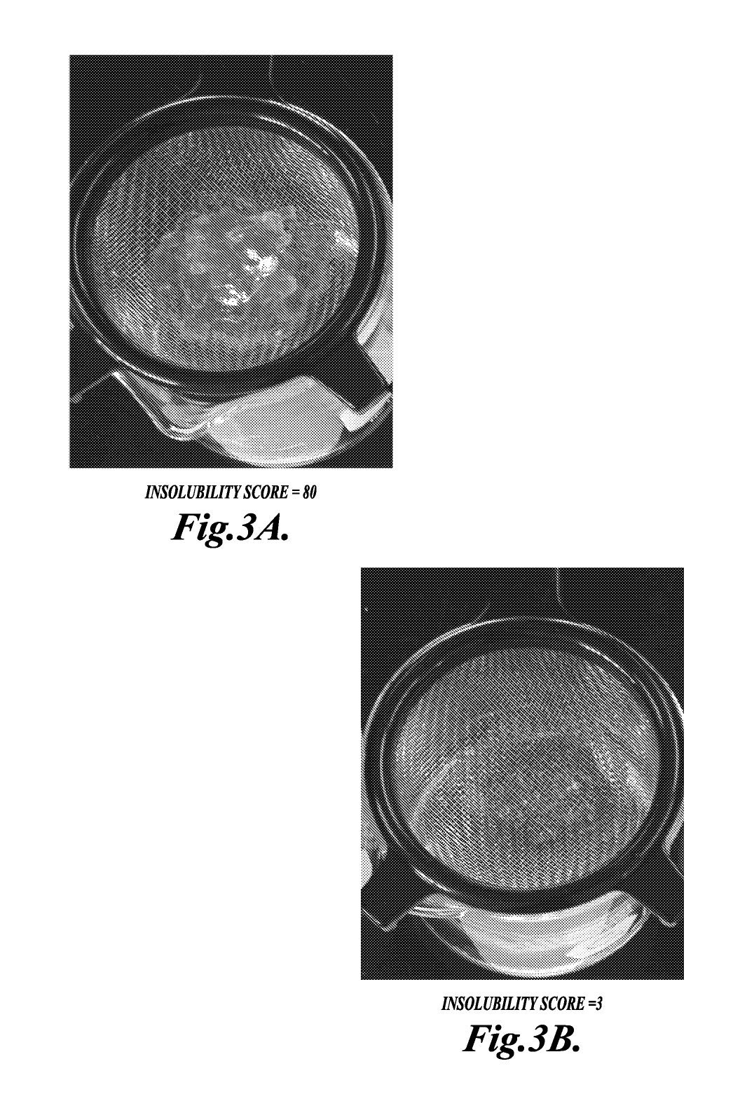

A comparison of soluble chitosan lactate salt to a relatively insoluble chitosan lactate salt presumed to have been exposed to high heat, humidity, or a combination of both is shown in FIGS. 3A and 3B. In FIGS. 3A and 3B, the relatively insoluble sample contained a significant quantity of gels compared to the soluble sample. The high Insolubility Score of 80 for the former would indicate that this lot would likely swell and fail to release the chitosan lactate into the water flow. In contrast, the sample with an Insolubility Score of 3 dissolves readily and releases from the sachet as expected without swelling.

### Example 3

### Analyzing the Effects of Heat and Moisture on Chitosan Salt Properties

The combined effect of heat and moisture was examined using a known, highly soluble chitosan lactate test sample. The objective was to determine if this highly soluble chitosan lactate could be made insoluble under the conditions of heat and moisture. A sample was placed in a large glass jar containing a smaller vial of water in order to increase the humidity in the environment that the chitosan lactate salt was exposed to under heat. The large jar was sealed and heated at 55° C. over a period of 34 days. The control sample was kept at room temperature with no added moisture. Test and control samples were removed at various time points and examined for solubility in the Conical Tube/Screen Assay described above.

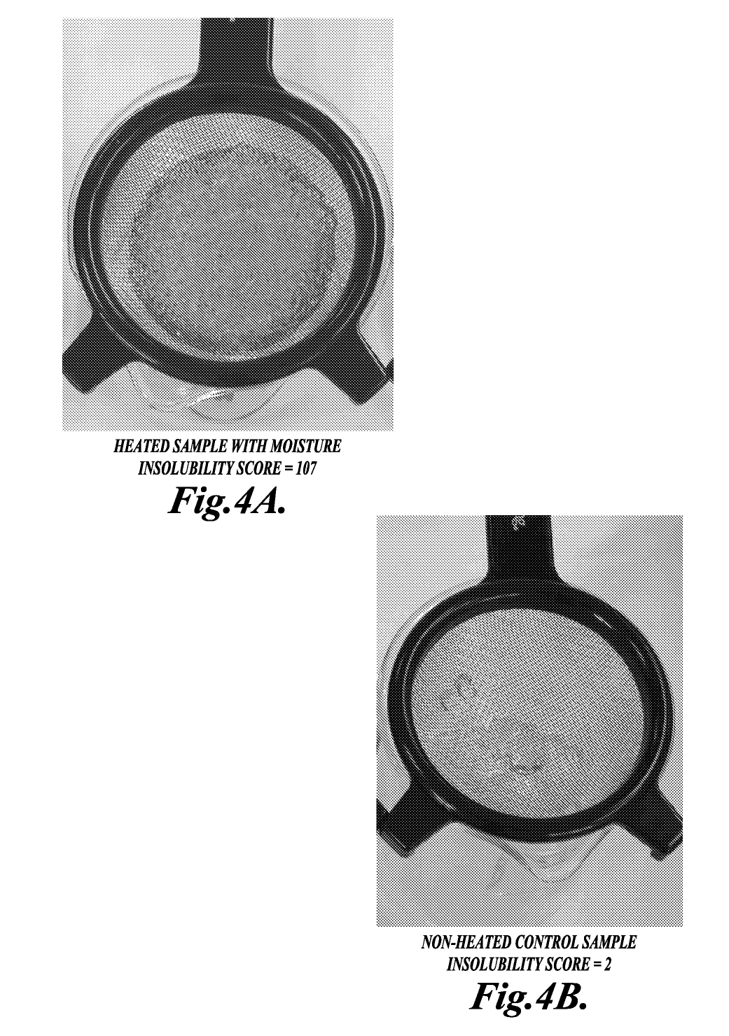

Preliminary evaluation of the test sample heated at 55° C. for 7 days demonstrated that the chitosan lactate was still quite soluble. After 13 days at 55° C., the chitosan lactate of the test sample was visually brown in color and was insoluble, exhibiting many gels and the water that it was added to had an amber hue. After 34 days at 55° C., a significant quantity of insoluble gels was observed in the test sample and the Insolubility Score was determined to be 107 compared to the non-heated soluble control with an Insolubility Score of 2. The heated test sample was analyzed for moisture and exhibited 19.64% moisture at the beginning of the Conical Tube/Screen Assay. As shown in FIGS. 4A and 4B, heating of a soluble chitosan lactate salt in a moist environment over time has a dramatic effect on its solubility (the heated lot on the left screen is loaded with many insoluble tan gels compared to the few gels on the soluble right screen).

### Example 4

### Examining the Effect of Desiccant on Heat- or Moisture-Induced Insolubility

The ability of desiccants to prevent heat-induced insolublization of chitosan lactate salt was examined. The first series of tests took place with molecular sieves, followed by a comparison of the behavior of molecular sieves versus silica gel.

Molecular Sieves.

Chitosan lactate salt samples were placed in mylar (a polyester) bags and sealed with or without desiccant (molecular sieves obtained from Dessicare Inc., Specification No. MIL-D-3464, Type I&II). The desiccant to chitosan ratio was 29.15 g desiccant per 16 grams chitosan lactate salt (1.8 kg desiccant per kg of chitosan lactate salt). Mylar bags were placed in a 100° C. oven for 7 days or a 55° C. oven for 15 days. Controls were kept in plastic jars at ambient temperature.

After 7 days exposure to 100° C., samples were removed from the mylar packages and examined. The chitosan lactate flakes heated in mylar without desiccant exhibited a dark brown to black color. The chitosan lactate salt flakes heated in mylar containing a desiccant was oatmeal in color indicating that the desiccant could significantly impact the reaction taking place in the mylar packaging under heat. Samples were added to deionized water and examined for solubility.

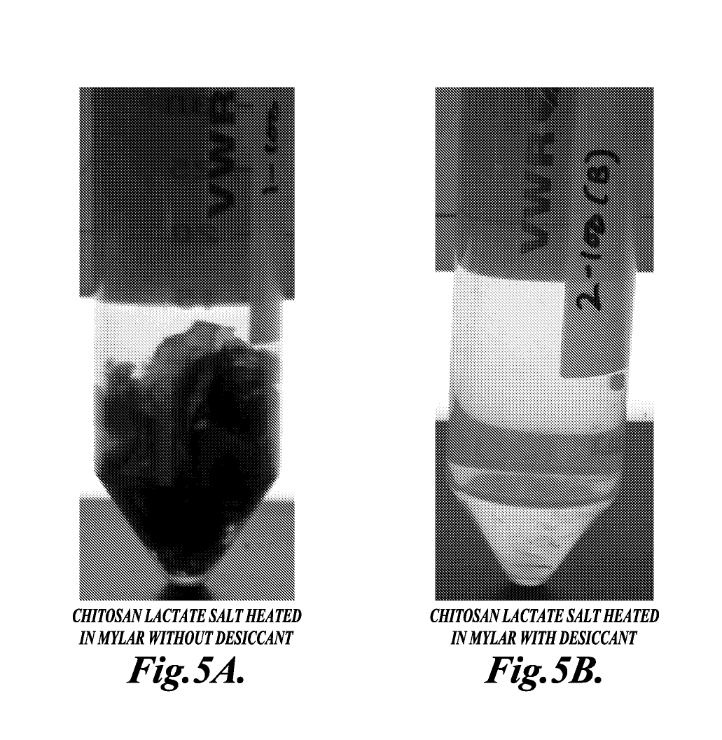

As shown in FIGS. 5A and 5B and discussed above, chitosan lactate salt heated in mylar to 100° C. for 7 days without desiccant turned reddish brown to black and did not dissolve in water (FIG. 5A) compared to chitosan lactate salt heated to 100° C. in mylar containing a desiccant for 7 days which was tan in color and dissolved in water (FIG. 5B).

The use of a molecular sieve desiccant during heating was capable of preventing the insolublization reaction of a chitosan lactate salt. It is believed that the desiccant prevents trapped moisture in the mylar bag from further reacting with chitosan.

The sachet release properties of chitosan samples in FIGS. 5A and 5B were measured over time. The sachet weight of the chitosan lactate salt sample of FIG. 5A continued to increase to >50 grams after 150 hours in water compared to the chitosan lactate salt sample of FIG. 5B, whose weight decreased to <20 grams after 150 hours. The use of a molecular sieve desiccant (at a ratio of 1.8 kg desiccant per kg chitosan lactate) was effective at mitigating the insolubilization produced as a result of exposure of chitosan lactate salt to extreme heat (100° C.) and moisture for 7 days.

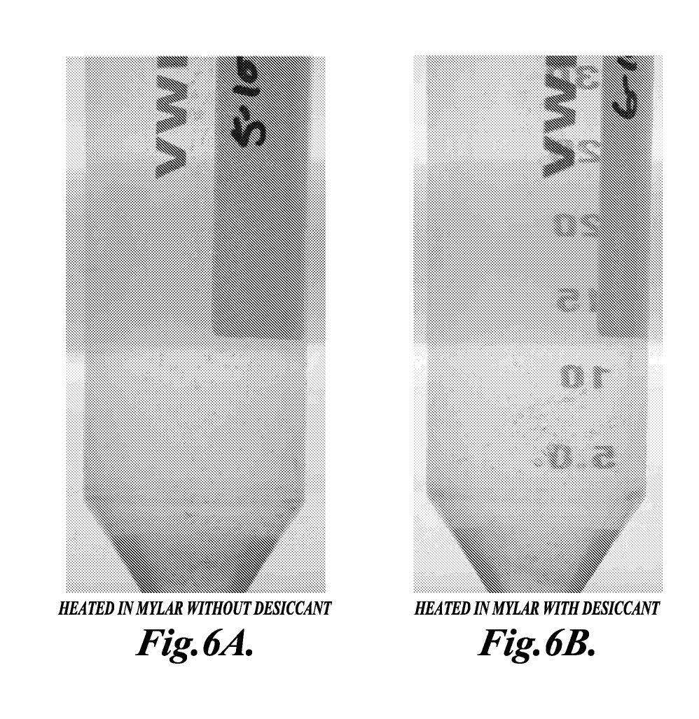

Exposure of the chitosan lactate salt to a constant temperature of 55° C., with or without desiccant, for a period of 15 days was also examined as shown in FIGS. 6A and 6B. At 55° C., following 15 days exposure, the insolubility difference between desiccant-containing and non-desiccant-containing heated samples was not as evident compared to exposure to 100° C. It is likely that a much longer heating time, combined with a higher moisture, is required in order to dramatically affect solubility as was observed in FIGS. 4A and 4B. Alternatively, a longer heating time at the constant moisture may be required to insolubilize the chitosan lactate salt.

The idea that a longer exposure time at 55° C. in order to insolubilize chitosan lactate salt was supported by experiments using actual segmented Gel-Floc™ sock devices containing chitosan lactate salts exposed at 55° C. or 40° C. temperatures for a period of 28 days. In this experiment, single Gel-Floc™ sock devices containing 1 kg of chitosan lactate salt were sealed in mylar (with or without 100 g of silica gel desiccant per sock) and exposed to either 55° C. or 40° C. for 28 days. Another test sample consisted of exposure of a Gel-Floc™ sock device (containing chitosan lactate salt) to 55° C. without enclosure inside of a sealed mylar bag. (Previous laboratory experiments at 55° C. demonstrated that the solubility properties of chitosan lactate salt is not affected if the sample is exposed to this temperature over a period of time while allowing the moisture contained therein to escape into the oven environment). The control consisted of a Gel-Floc™ sock device containing chitosan lactate salt that was stored open at room temperature without the device being enclosed in mylar.

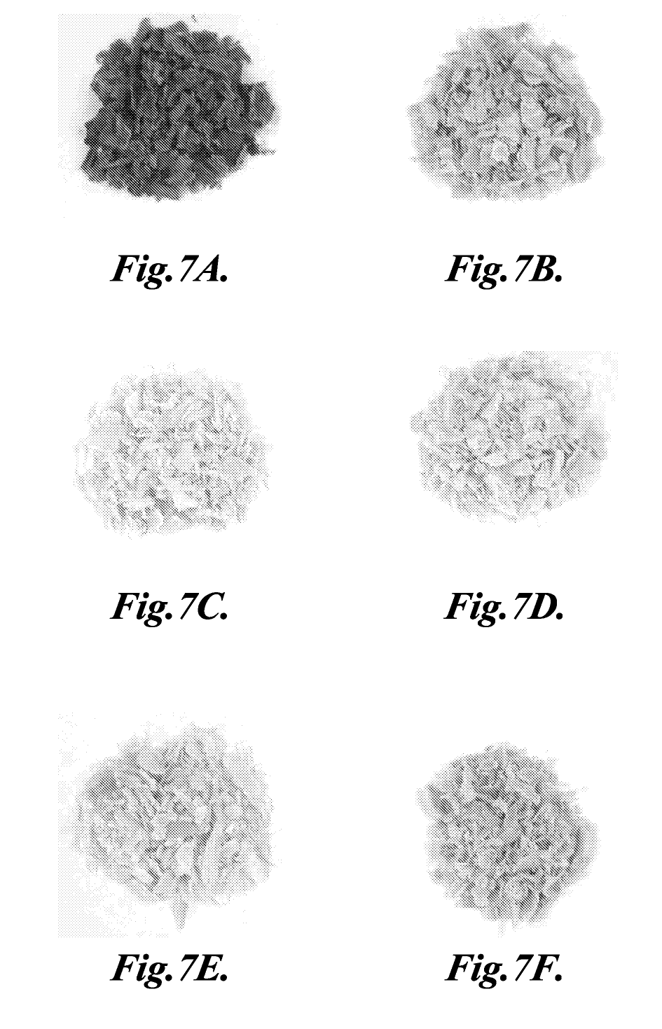

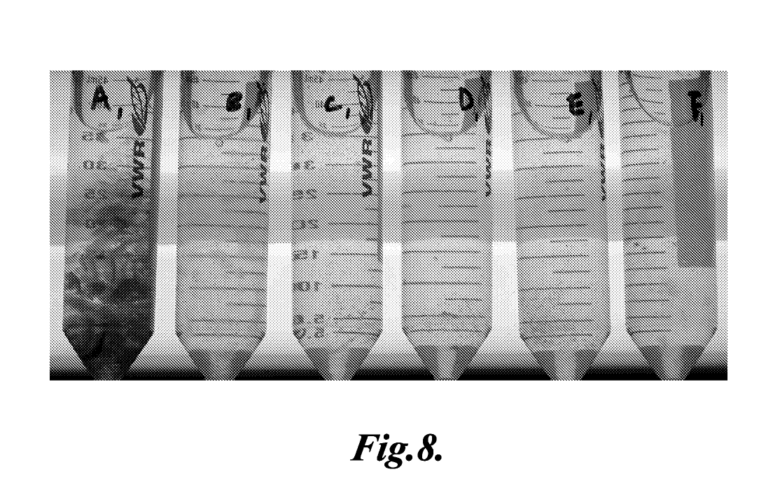

A comparison of the various exposed chitosan lactate salt samples removed from the devices following the various treatments is shown in FIGS. 7A-7F. The solubility of the chitosan lactates was examined using the Conical Tube/Screen Assay described in Example 1. The results are shown in FIG. 8. Exposure to 55° C. for 28 days clearly affected the non-desiccated chitosan lactate salt contained in the device stored in mylar. The effect was not as pronounced at 40° C. (compare tube A to tube F in FIG. 8) when examined for visual solubility in water. However, it was more evident in the color of the chitosan lactate salt flake as seen in FIGS. 7A-7F, sample E. Partially soluble flakes are seen in the 40° C. exposed sample in tube F of FIG. 8. The silica desiccant at both 55° C. and 40° C. did mitigate much of the browning reaction (indicative of insolubility) as can be seen in tubes B and E in FIG. 8.

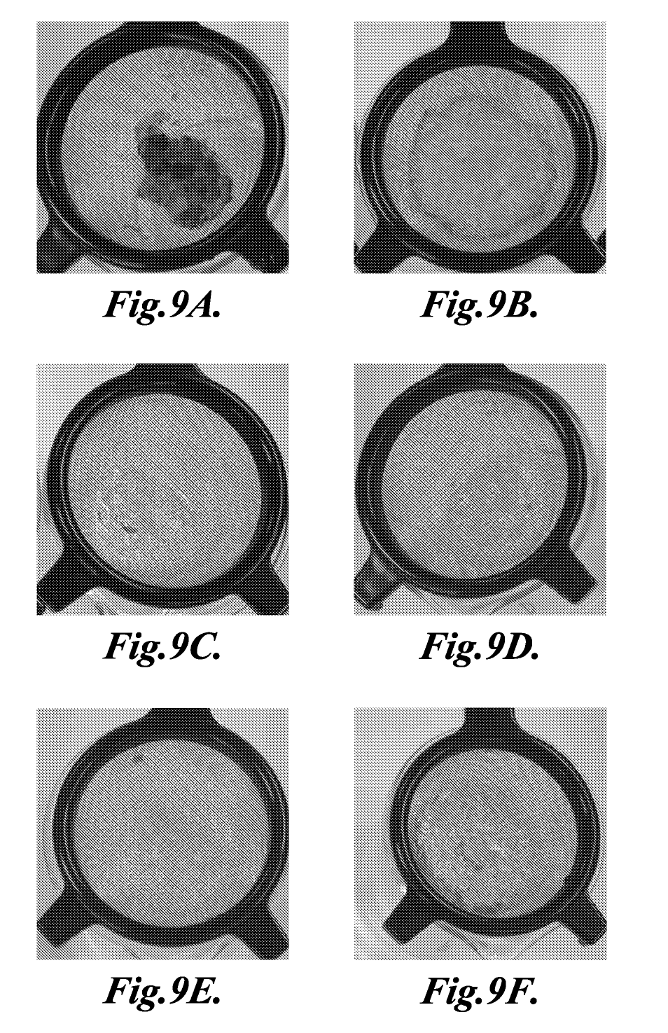

The insolubility becomes more evident when the sample solutions are poured through the kitchen strainer as described in the Conical Tube/Screen Assay as shown in FIGS. 9A-9F. The Insolubility Scores for samples A-F of FIG. 8 were determined as shown in Table 1. Devices containing chitosan lactate salts treated as described were also tested for solubility and release of the chitosan lactate salt contained in the device. Devices, also referred to as Gel-Floc™ socks, were placed inside of a pipe and water was flowed over the device continuously. The devices were scored based on swell size and release of the chitosan lactate salt contained within. Devices that swelled (similar to that observed in the Sachet Assay of Example 1) and did not release the soluble chitosan lactate salt were scored as failed or failing. Devices that decreased in their swelling and released soluble chitosan lactate salt (similar to that observed in the Sachet Assay) were scored as a pass.

TABLE 1
Insolubility score and predicted pass or fail comparison
for chitosan lactate samples from FIGS. 8 and 9A-9F.

| | | | | Predicted | Actual |
|---|---|---|---|---|---|
| | | | | Solubility of | Solubility of |
| | | Percent | | Chitosan | Chitosan |
| | | Moisture | Insol- | Lactate Salt | Lactate Salt |
| Sam- | | after 28 | ubility | Release from | Released from |
| ple | Description | days | Score | Device | Device |
| A | 28 days at | 9.68% | 23 | Fail | Failed |
| | 55° C. in | | | | |
| | mylar, no | | | | |
| | desiccant | | | | |
| B | 28 days at | 1.89% | 66 | Fail | Failing |
| | 55° C. in | | | | |
| | mylar, + | | | | |
| | desiccant | | | | |
| C | 28 days at | 0.60% | 9 | Pass | Passed |
| | 55° C. | | | | |
| | exposed | | | | |
| | open in oven | | | | |
| D | Stored at | 7.56% | 6 | Pass | Passed |
| | room | | | | |
| | temperature | | | | |
| | in the sealed | | | | |
| | bucket | | | | |
| E | 28 days at | 1.70% | 6 | Pass | ND |
| | 40° C. in | | | | |
| | mylar, + | | | | |
| | desiccant | | | | |
| F | 28 days at | 8.09% | 56 | Fail | ND |
| | 40° C. in | | | | |
| | mylar, no | | | | |
| | desiccant | | | | |

Based on the Insolubility Scores determined in the Conical Tube/Screen Assay, it is likely that 100 grams of silica gel desiccant per 1 kg of chitosan lactate salt contained in a device would be ineffective at preventing failure of a sock exposed to a constant temperature of 55° C. for a period of 28 days (sample B). However, it is likely that 100 g of silica gel per 1 kg of chitosan lactate salt contained in a device would be sufficient to prevent failure of a device containing chitosan lactate salt exposed to a constant temperature of 40° C. for a period of 28 days (sample E).

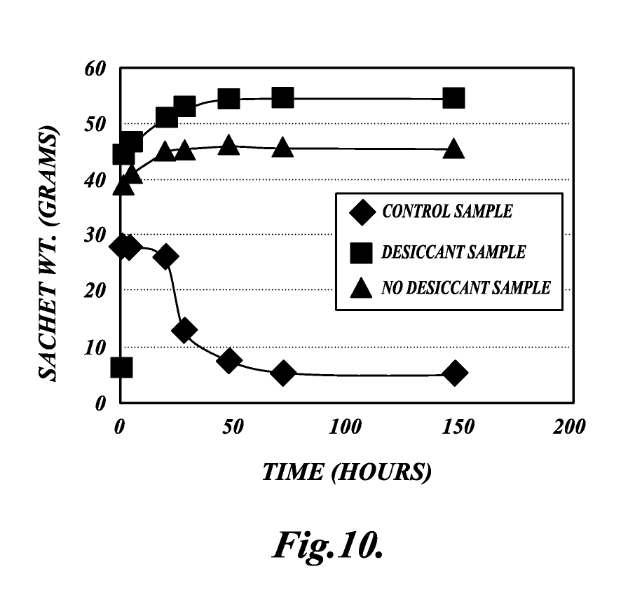

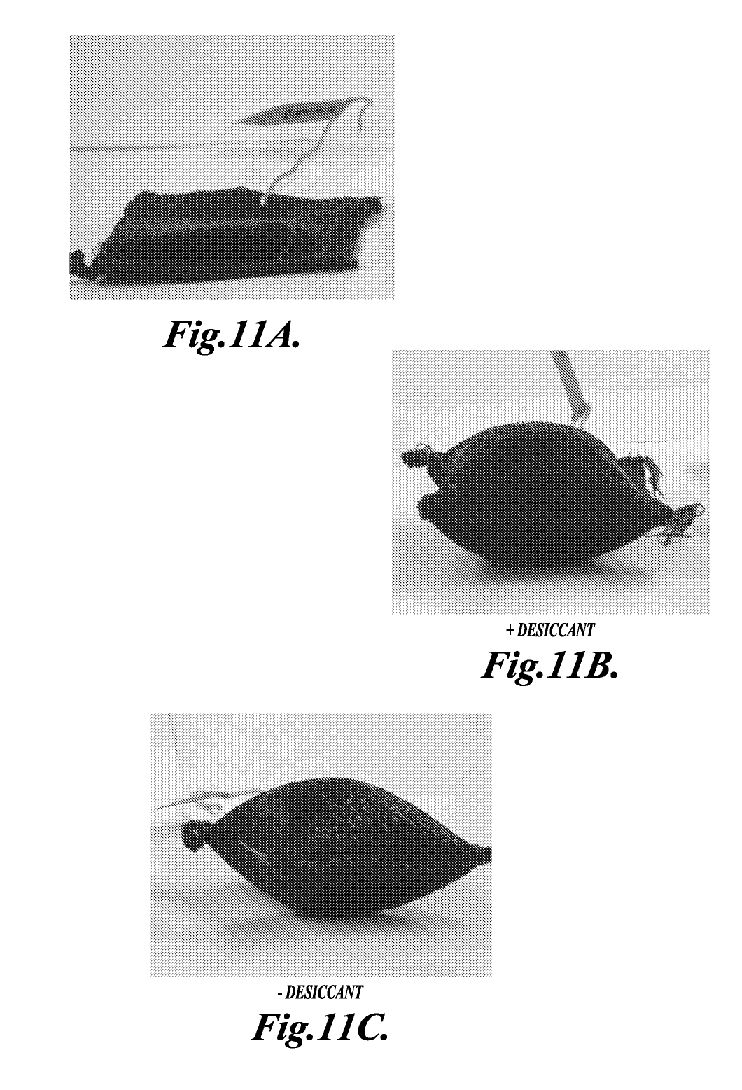

The predicted failures noted in Table 1 are supported by experiments comparing Insolubility Scores of chitosan lactate salts to release kinetics from sachets over time as shown in Table 2 and FIGS. 10 and 11A-11C. In this experiment, soluble chitosan lactate salt was placed in a sealed mylar bag, with or without silica gel desiccant (0.5 g desiccant/5 g of chitosan lactate), and exposed to a constant temperature of 55° C. for a period of 14 days. The control chitosan lactate salt was retained in a Ziplock® bag at ambient (room temperature) temperature since the date of manufacture.

TABLE 2
Insolubility Scores and Actual Pass/Fail (from data presented
in FIGS. 11A-11C) Comparisons for Chitosan Lactate Samples
Exposed to 55° C. in the Presence or Absence of 100
g Silica Gel per kg of Chitosan Lactate Salt.

| | | Insolubility | Sachet |
|---|---|---|---|
| Sample | Description | Score | Pass/Fail |
| Control | Stored in plastic | 0.98 | Pass |
| | bag at ambient | | |
| | temperature | | |
| Mylar + desiccant | Stored in mylar with | 33 | Fail |
| | desiccant at 55° C. | | |
| | for 14 days | | |
| Mylar no desiccant | Stored in mylar, no | 35 | Fail |
| | desiccant, at 55° C. | | |
| | for 14 days | | |

The foregoing demonstrates that the Insolubility Score can be used as an indicator for predicting the likelihood of a given chitosan lactate salt to perform or fail in a sachet and ultimately in a Gel-Floc™ sock device in the field. Testing of the Gel-Floc™ sock devices described in FIGS. 7A-7F, 8, and 9A-9F and Table 1 confirm the predicted results from the Insolubility Scores.

Molecular Sieves Versus Silica Gel.

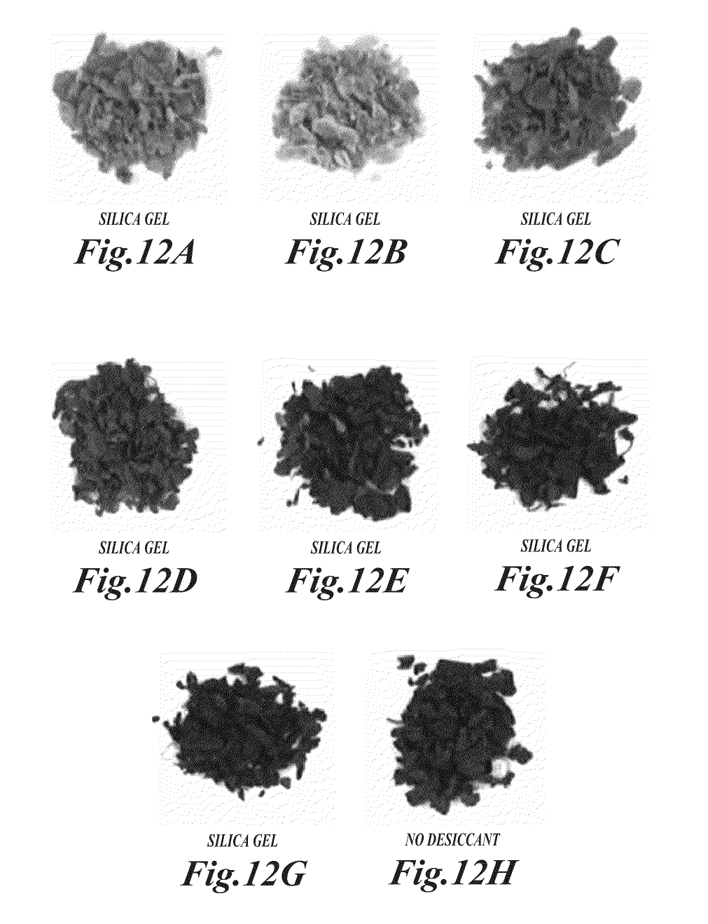

Molecular sieve and silica gel desiccants were compared in their ability to prevent heat induced browning (an indicator of insolubility) of chitosan lactate salt. As seen in FIGS. 12A-12O, molecular sieves were superior to silica gel on an equal weight basis in mitigating the brown to black color that is indicative of insolubilization caused by heat and moisture (compare upper panel to lower panel).

The lower ratios were examined at 55° C., a lesser extreme, compared to 100° C. The same soluble chitosan lactate salt used in the 100° C. experiment was used in a 55° C. experiment. Equal weights of chitosan lactate salt samples were placed in mylar with or without desiccant (either silica gel or molecular sieves) and sealed. Varying ratios of desiccant to chitosan lactate salt were examined ranging from 902 grams of desiccant per kg of chitosan lactate salt down to 113 grams of desiccant per kg of chitosan lactate salt. The sealed mylar bags were exposed to a constant 55° C. for 16 days and then examined by the Conical Tube/Screen Assay of Example 1. Results are shown in Table 3.

TABLE 3
Conical Tube/Screen Assay Comparison of Different Desiccants
for Their Ability to Prevent Heat/Moisture-Induced Chitosan
Lactate Insolubility. All sealed mylar samples were heated
at a constant temperature of 55° C. for a period of 16
days. Control was heated in sealed mylar without desiccant.

| | | | | Predicted |
|---|---|---|---|---|
| | | | | Solubility of |
| | | Visual | | Chitosan Lactate |
| Sample | Swell | Solubility | Insolubility | Salt Released |
| Description | Value | Score | Score | from Device |
| Mol. Sieve at | 23.56 | 2 | 47 | Fail |
| 113 g/kg | | | | |
| chitosan lactate | | | | |
| salt | | | | |
| Silica Gel at | 39.33 | 2 | 79 | Fail |
| 113 g/kg | | | | |
| chitosan lactate | | | | |
| salt | | | | |
| Mol. Sieve at | 4.91 | 2 | 10 | Pass |
| 226 g/kg | | | | |
| chitosan lactate | | | | |
| salt | | | | |
| Silica Gel at | 37.39 | 2 | 75 | Fail |
| 226 g/kg | | | | |
| chitosan lactate | | | | |
| salt | | | | |
| Mol. Sieve at | 4.53 | 2 | 9 | Pass |
| 451 g/kg | | | | |
| chitosan lactate | | | | |
| salt | | | | |
| Silica Gel at | 6.37 | 2 | 13 | Pass |
| 451 g/kg | | | | |
| chitosan lactate | | | | |
| salt | | | | |
| Mol. Sieve at | 4.36 | 2 | 9 | Pass |
| 902 g/kg | | | | |
| chitosan lactate | | | | |
| salt | | | | |
| Silica Gel at | 7.86 | 2 | 16 | Pass |
| 902 g/kg | | | | |
| chitosan lactate | | | | |
| salt | | | | |
| Control, no | 42.07 | 2 | 84 | Fail |
| desiccant | | | | |

The results from Table 3 show that molecular sieve desiccants are better at preventing insolubility of chitosan lactate salts on an equal weight basis compared to silica gel desiccants. As demonstrated by the Insolubility Scores, both molecular sieves and silica gel fail at 113 grams per kg chitosan lactate salt. At 226 grams per kg chitosan lactate salt, molecular sieve desiccants are effective at preventing heat/moisture-induced insolubility while silica gel desiccants fail. Silica gel desiccants begin to perform at 451 grams per kg chitosan lactate salt. At 226 grams, molecular sieve desiccants and 451 grams of silica gel desiccants per kg chitosan lactate salt, it is reasonable to expect Gel-Floc™ socks would be functional after constant exposure to 55° C. for a period of 16 days. It is reasonable to expect that once the moisture is contained within the correct amount of desiccant, the stability and solubility of the chitosan lactate salt should be maintained for years.

### Example 5

### Effect of Desiccant on Maintaining Solubility of Chitosan in Solid Chitosan/Solid Acid Blends

Whether the same stabilizing effect of desiccants as observed above could be realized with solid chitosan/solid acid mixtures was examined.

Shelf life testing of sachets (see Example 1) at 55° C. were conducted under 4 conditions. Five different admixtures of solid chitosan/solid acid blends were made and placed into sachets. The acids used were solid lactic, solid malic, solid glutamic, solid adipic, and solid benzoic. Then sachets from each of the different admixtures were then placed separately into each one of 4 different conditions in a 55° C. oven. The first condition was a sealed mylar bag (“as is”), the second condition was a sealed mylar bag with one unit of molecular sieves (“desiccant”). The third condition was a sealed mylar bag with additional “moisture” (moist paper towel) and the last condition was “open” to the oven with no mylar bag.

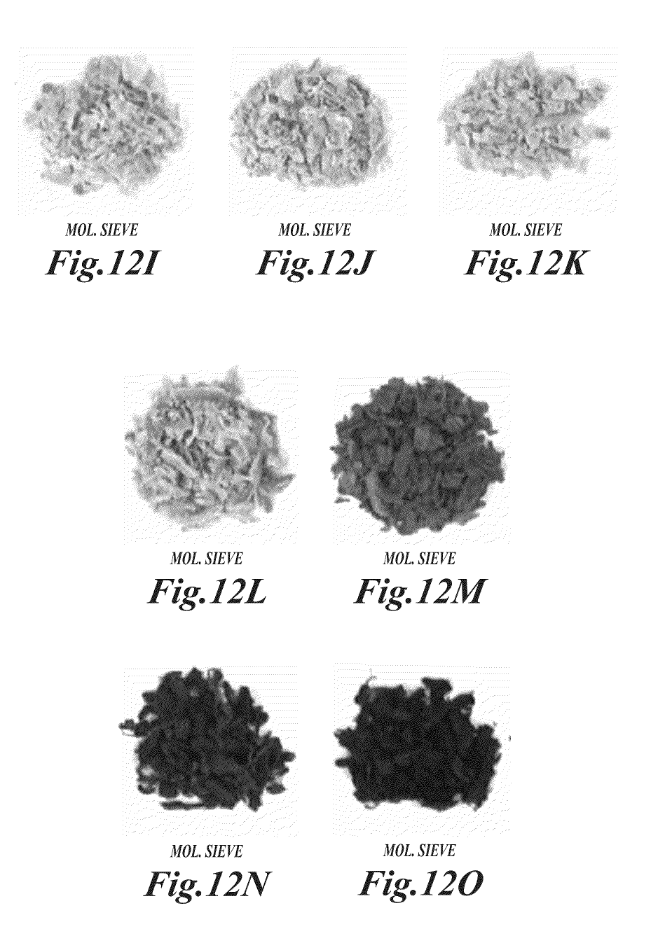

FIG. 13 depicts the admixtures of the solid chitosan/solid acid blends after 2 weeks at 55° C. Four different conditions were tested. In the first condition the samples were sealed “as is” in a mylar bag. After 2 weeks at 55° C., the admixtures slightly darkened to a light tan color versus the off-white color before heating. The second set of samples, sealed in mylar with a “desiccant,” did not seem to change color and exhibited the off-white color observed before heating. The third set of samples was sealed in mylar with additional “moisture.” After 2 weeks at 55° C., they turned much darker, ranging from a tan to dark brown color. The fourth set of samples was “open” to the oven and remained the off-white color observed before heating.

As was seen with chitosan lactate salts under the same conditions, the admixtures of solid chitosan/solid acid blends exhibit similar color change differences demonstrating that they are also sensitive to the effects of moisture with heat.

The solubility of the admixtures of solid chitosan/solid acid blends was examined further using a modification of the Conical Tube/Screen Assay of Example 1. Since the particles were −20 mesh and not flake as described in the test, an adjustment of the visual portion was made to accommodate for the reduced particle size. It was difficult to get a good Swell Value on the samples and the value was collected as best as possible. The criteria for the test is as listed: Insolubility Score (IS)<20 with Visual Solubility Scores (VSS) of 1 or 2=Pass. Insolubility Score <20 with Visual Solubility Score of 3=Fail. Insolubility Score >20 with Visual Solubility Score of 1, 2, or 3=Fail.

The samples stored “as is” in mylar had a Visual Solubility Score (VSS) of 1 to 2 and a Swell Value (SV) of about 10-40 for a Insolubility Score (IS) of about 10-80, a range of passing to failure. The samples stored with a “desiccant” in mylar had a VSS of 1 and a SV of 2 for a IS of 2, which passes the solubility test. The samples stored with “moisture” in mylar had a VSS of 3 and a SV of 4 for a IS of 12, which fails the solubility test. The samples stored open in the oven had a VSS of 1 and a SV of 2 for a IS of 2, which passes the solubility test. This data again demonstrates that the samples stored with moisture (existing or additional) and subjected to heat are affected and exhibit reduced solubility. It is also observed that the inclusion of a desiccant prevents the insolubilization of the chitosan contained in water-soluble admixtures of solid chitosan/solid acid blends.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method of preventing or decreasing insolubilization of a chitosan-containing composition, the method comprising: placing a desiccant in a moisture-resistant container with a chitosan-containing composition,
wherein the chitosan-containing composition is chosen from:
a chitosan salt;
a blend of (1) a solid chitosan that may be partially protonated but is greater than 80% insoluble when added to water and in a dry, free-flowing, particulate form, and (2) a solid acid or a solid agent that generates a proton in situ in the presence of water; and
a chitosan derivative, and
wherein the amount of desiccant is sufficient to prevent or decrease insolubilization of the chitosan-containing composition.

2. The method of claim 1, wherein the moisture-resistant container comprises mylar.

3. The method of claim 1, wherein the desiccant is one or more desiccants selected from the group consisting of molecular sieves, silica gel, montmorillonite clay, indicating silica gel, calcium oxide, calcium sulfate, and activated alumina.

4. The method of claim 1, further comprising sealing the moisture-resistant container.

5. A method of solubilizing a chitosan-containing composition, comprising:
(a) opening a sealed moisture-resistant container comprising a desiccant and a formulation comprising the chitosan-containing composition,
wherein the chitosan-containing composition is chosen from:
a chitosan salt;
a blend of (1) a solid chitosan that may be partially protonated but is greater than 80% insoluble when added to water and in a dry, free-flowing, particulate form, and (2) a solid acid or a solid agent that generates a proton in situ in the presence of water; and
a chitosan derivative, and
wherein the amount of desiccant is sufficient to prevent or decrease insolubilization of the chitosan-containing composition, and
(b) exposing the chitosan-containing composition to water to solubilize the chitosan-containing composition.

6. The method of claim 5, wherein the desiccant is comprised in a desiccant-containing sachet.

7. The method of claim 6, further comprising removing the desiccant-containing sachet from the moisture-resistant container after (a) but before (b).

8. A method of desiccating a formulation comprising a chitosan-containing composition, the method comprising: sealing a formulation comprising the chitosan-containing composition and a desiccant in a moisture-resistant container,
wherein the chitosan-containing composition is chosen from:
a chitosan salt;
a blend of (1) a solid chitosan that may be partially protonated but is greater than 80% insoluble when added to water and in a dry, free-flowing, particulate form, and (2) a solid acid or a solid agent that generates a proton in situ in the presence of water; and
a chitosan derivative, and
wherein the amount of desiccant is sufficient to prevent or decrease insolubilization of the chitosan-containing composition.

9. The method of claim 8, wherein the desiccant is one or more desiccants selected from the group consisting of molecular sieves, silica gel, montmorillonite clay, indicating silica gel, calcium oxide, calcium sulfate, and activated alumina.

10. A method for preventing or decreasing insolubilization of a chitosan-containing composition, comprising:
(a) reducing moisture within a container to provide a low-moisture container;
(b) placing a chitosan-containing composition within the low-moisture container; and
(c) sealing the low-moisture container.

11. The method of claim 10, wherein the desiccant is one or more desiccants selected from the group consisting of molecular sieves, silica gel, montmorillonite clay, indicating silica gel, calcium oxide, calcium sulfate, and activated alumina.

12. The method of claim 10, wherein the chitosan-containing composition is chosen from:
a chitosan salt;
a blend of (1) a solid chitosan that may be partially protonated but is greater than 80% insoluble when added to water and in a dry, free-flowing, particulate form, and (2) a solid acid or a solid agent that generates a proton in situ in the presence of water; and
a chitosan derivative.

13. The method of claim 12, wherein the low-moisture container contains less than 10% moisture by weight relative to the weight of the chitosan-containing composition.

14. A method of preventing or decreasing insolubilization of a chitosan-containing composition, comprising:
(a) packaging a water soluble chitosan containing composition in a container; and
(b) maintaining the composition to a temperature to maintain the water-solubility of the chitosan-containing composition when exposure to ambient temperature would otherwise result in the insolubility of the chitosan-containing composition.

15. The method of claim 14, wherein the container comprises moisture in an amount sufficient to cause insolubility when (b) is not performed.

16. The method of claim 14, further comprising refrigerating the container after (a) and before opening the container.
